(19) United States
(12) Patent Application Publication
(10) Pub. No.: US 2026/0236265 A1
(43) Pub. Date: Aug. 13, 2026

(54) SYSTEM ON CHIP, INSTRUCTION SYSTEM, COMPILATION SYSTEM, AND RELATED PRODUCT

(71) Applicant: Shanghai Cambricon Information Technology Co., Ltd., Shanghai (CN)

(72) Inventors: Zhenxing ZHANG, Shanghai (CN); Shaoli LIU, Shanghai (CN)

(73) Assignee: Shanghai Cambricon Information Technology Co., Ltd., Shanghai (CN)

(21) Appl. No.: 18/878,871

(22) PCT Filed: Jun. 28, 2023
(86) PCT No.: PCT/CN2023/103246

§ 371 Date: Oct. 17, 2025

(30) Foreign Application Priority Data
Jun. 29, 2022 (CN) 202210764227.8

(51) Int. Cl. G06F 9/38; G06F 9/30

(52) U.S. Cl. CPC G06F 9/3802; G06F 9/30054; G06F 9/3861

(57) ABSTRACT

The present disclosure provides an SoC, an instruction system, a compilation system and related products. The SoC includes a plurality of heterogeneous IP cores. By managing heterogeneous IP cores as execution units in a hardware pipeline, the solution of the present disclosure hides the heterogeneity of the IP cores, thereby improving programming efficiency and hardware utilization.

### CROSS REFERENCE TO RELATED APPLICATION

The present application claims priority to Chinese Patent Application No. 202210764227.8 with the title of “System on Chip, Instruction System, Compilation System, and Related Product” filed on Jun. 29, 2022.

### TECHNICAL FIELD

The present disclosure generally relates to the field of system on chip (SoC). More specifically, the present disclosure relates to an SoC, an instruction processing apparatus, an instruction execution method, a compilation apparatus, a compilation method, a board card, and a machine-readable storage medium.

### BACKGROUND

Performance gain of a general central processing unit (CPU) continues to decline due to the end of Moore's Law and Dennard Scaling. Domain-specific architecture (DSA) has emerged as the most promising and feasible way to continue to improve the performance and efficiency of an entire computing system. The DSA comes with a great explosion and is believed to open up a new golden age of a computer architecture. Various DSAs have been proposed to accelerate certain applications, for example, various xPUs, including a data processing unit (DPU) for data flow processing, a graphics processing unit (GPU) for graphics processing, a neural network processing unit (NPU) for neural networks, a tensor processing unit (TPU) for tensor processing, and the like. As more DSAs, especially those for computing purposes (also called intellectual property (IP)), are integrated into an SoC for high efficiency, heterogeneity of hardware in a current computing system continues to increase, changing from standardization to customization.

Currently, IP typically exposes only IP-related hardware interfaces, forcing the SoC to utilize code running on a host CPU and manage the IP as a separate device. Much effort is often spent building a programming framework to help application developers manage this hardware heterogeneity because it is extremely difficult to manage hardware heterogeneity directly for application developers. For example, popular programming frameworks for deep learning include PyTorch, TensorFlow, MXNet, and so on, all of which provide advanced, easy-to-use Python interfaces for application developers.

Unfortunately, this heterogeneity of software management in a CPU-centric SoC prevents user applications from running efficiently on different SoCs due to low productivity and low hardware utilization. Low productivity stems from both programming frameworks and applications. For programming framework developers, in order to support different SoCs, programming frameworks must implement their own high-level abstract interfaces using different IPs, which requires a lot of development work. For application developers, differences among different IPs in the SoC require different implementations of the same application, resulting in a heavy programming burden. Moreover, this may be even worse for IPs that are not supported by programming frameworks, as hardware heterogeneity needs to be managed manually. Low hardware utilization is associated with CPU-centric SoCs and IPs with certain generalities. In a current SoC, a host CPU must treat IP as a separate device and utilize code running on the host CPU (in other words, CPU-centric) to manage collaboration among different IPs, resulting in non-negligible overheads in both control and data exchange. In addition, with the integration of many IPs with certain generalities, domain-specific programming frameworks may not be able to use IPs available in other fields to perform the same function. For example, using a deep learning accelerators (DLA) requires explicit programming in Nivdia Tegra Xavier.

However, there is currently little research investigating programming productivity issues due to increased hardware heterogeneity, with much of the research still focusing on improving the performance and energy efficiency of a single IP. Some work develops SoC performance by scheduling IPs by chain for stream-based applications in certain scenarios or by adding shortcuts to hardware. A fractal method is also proposed to solve the programming productivity problem, but the method is performed on machine learning accelerators of different scales. As a result, the ever-growing hardware heterogeneity has revolutionized the paradigm for building future SoC systems and raised key issues about how to build SoC systems with high productivity and high hardware utilization.

### SUMMARY

In order to at least partly solve one or a plurality of technical problems mentioned in the background, the present disclosure provides a solution in many aspects. A first aspect of the present disclosure provides an SoC-as-a-processor (SaaP), which is a novel unified system on chip architecture framework, which eliminates hardware heterogeneity from the software perspective, to improve programming productivity and hardware utilization. A second aspect of the present disclosure provides an architecture-free mixed-scale instruction cluster, to support high productivity and new components of SaaP, including vesicles for on-chip management and on-chip interconnections for data paths, thus creating an efficient SaaP architecture. A third aspect of the present disclosure provides a compilation method for compiling program code of various high-level programming languages into mixed-scale instructions. Other aspects of the present disclosure provide solutions for branch predictions, exceptions, and interrupts in instructions.

A first aspect of the present disclosure discloses an SoC, including: a system controller configured to manage a hardware pipeline, including fetching an instruction from a system memory, decoding and dispatching the instruction; and a plurality of heterogeneous IP cores constituting execution units in the hardware pipeline for executing the instruction dispatched by the system controller.

A second aspect of the present disclosure discloses a board card, including the SoC of the above first aspect.

According to the SoC and board card provided above, a novel unified architecture may be provided for an SoC with heterogeneous IP cores. By treating heterogeneous IP cores as execution units on a hardware pipeline, heterogeneity of IP cores may be hidden from the software, thus improving programming efficiency and hardware utilization.

### BRIEF DESCRIPTION OF DRAWINGS

By reading the following detailed description with reference to drawings, the above and other objects, features and technical effects of exemplary implementations of the present disclosure will become easier to understand. In the drawings, several implementations of the present disclosure are shown in an exemplary but not restrictive manner, and the same or corresponding reference numerals indicate the same or corresponding parts.

FIG. 1 exemplifies a typical SoC architecture.

FIG. 2 illustrates hardware heterogeneity on an SoC.

FIG. 3 illustrates a typical timeline of a traditional SoC.

FIG. 4a illustrates an SaaP architecture according to an embodiment of the present disclosure using a simplified diagram.

FIG. 4b illustrates a traditional SoC architecture as a comparison.

FIG. 5 illustrates an overall SaaP architecture according to an embodiment of the present disclosure.

FIG. 6 exemplifies an example process for performing a task on a mixed-scale instruction set computer (MISC) architecture.

FIG. 7 illustrates an exemplary flowchart of an instruction execution method according to an embodiment of the present disclosure.

FIG. 8 illustrates an exemplary flowchart of an instruction execution method for a branch instruction according to an embodiment of the present disclosure.

FIG. 9 illustrates an exemplary flowchart of an instruction execution method according to an embodiment of the present disclosure.

FIG. 10 illustrates an instruction execution example according to an embodiment of the present disclosure.

FIG. 11 illustrates several different data path designs.

FIG. 12 illustrates an exemplary flowchart of a compilation method according to an embodiment of the present disclosure.

FIG. 13 illustrates an exemplary program.

FIG. 14 illustrates a schematic diagram of a structure of a board card according to an embodiment of the present disclosure.

### DETAILED DESCRIPTION

Technical solutions in embodiments of the present disclosure will be described clearly and completely hereinafter with reference to drawings in the embodiments of the present disclosure. Obviously, embodiments to be described are merely some rather than all embodiments of the present disclosure. All other embodiments obtained by those skilled in the art based on the embodiments of the present disclosure without creative efforts shall fall within the scope of protection of the present disclosure.

It should be understood that terms such as “first”, “second”, “third”, and “fourth” appear in the claims, specification, and drawings are used for distinguishing different objects rather than describing a specific order. It should be understood that terms “including” and “comprising” used in the specification and the claims indicate the presence of a feature, an entity, a step, an operation, an element, and/or a component, but do not exclude the existence or addition of one or a plurality of other features, entities, steps, operations, elements, components, and/or collections thereof.

It should also be understood that the terms used in the specification of the present disclosure are merely intended to describe a specific embodiment rather than to limit the present disclosure. As being used in the specification and the claims of the present disclosure, unless the context clearly indicates otherwise, singular forms such as “a”, “an”, and “the” are intended to include plural forms. It should also be understood that a term “and/or” used in the specification and the claims refers to any and all possible combinations of one or a plurality of relevant listed items and includes these combinations.

As being used in the specification and the claims of the present disclosure, a term “if”′ may be interpreted as “when”, or “once” or “in response to a determination” or “in response to a case where something is detected” depending on the context.

SoC is an integrated circuit chip that integrates all key components of a system on a same chip. The SoC is the most common integration solution in mobile/edge scenarios at present. Its high level of integration improves system performance, reduces overall power consumption, and provides a much smaller area cost compared to motherboard-based solutions.

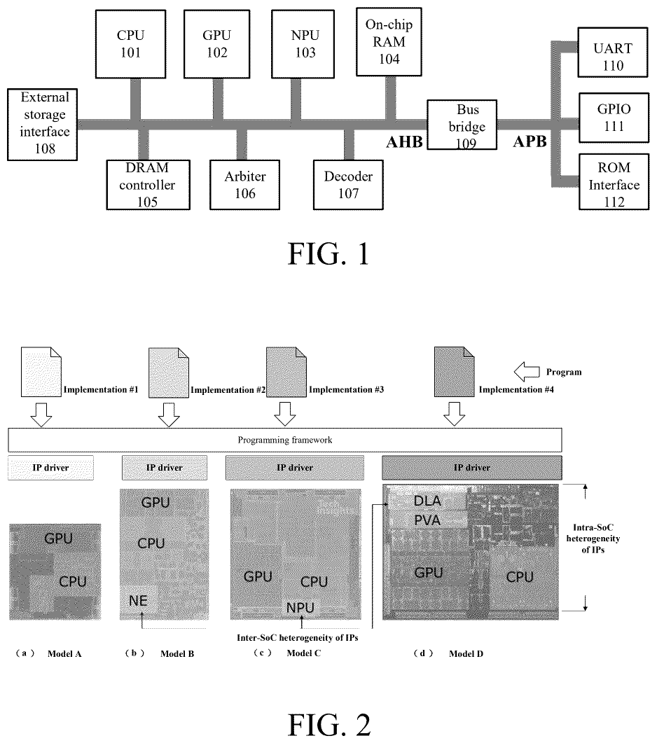

FIG. 1 exemplifies a typical SoC architecture.

Due to performance requirements under a limited area/power budget, SoCs typically integrate many dedicated hardware IPs, usually domain-specific architectures for computing purposes, especially to accelerate domain-specific applications or specific applications. Some of these hardware IPs are customized by SoC designers, such as neural network processing IPs (a neuron engine (NE) in Apple A15, a deep learning accelerator (DLA) in NVIDIA Jetson Xavier, a neural network processing unit (NPU) in HiSilicon Kirin, and Samsung Exynos. Some are standardized by IP vendors, such as a CPU and GPU of Arm or Imagination, a digital signal processor (DSP) of Synopsys or Cadence, a field-programmable gate array (FPGA) of Intel or Xilinx, and the like.

In the example of FIG. 1, a CPU 101, a GPU 102, an NPU 103, an on-chip random access memory (RAM) 104, a dynamic random access memory (DRAM) controller 105, an arbiter 106, a decoder 107, an external storage interface 108, a bus bridge 109, a universal asynchronous receiver/transmitter (UART) 110, a general purpose input output (GPIO) 111, and a read only memory (ROM) interface 112 are shown.

Traditional SoC is designed using a shared data bus or a network on chip (NoC) to link components together. A common bus used for SoC on-chip interconnection is an advanced microcontroller bus architecture (AMBA), which is an open standard of ARM.

In the example in FIG. 1, the SoC connects and manages various functional blocks in the SoC using shared buses. These shared buses include an advanced high performance bus (AHB) for high-speed connection, and an advanced peripheral bus (APB) for low-bandwidth and low-speed connection. Other network-class topologies, also known as NoC, may also be introduced to manage more components using a router-based packet interaction network.

Integrating a plurality of different IPs results in hardware heterogeneity on the SoC. The hardware heterogeneity includes intra-SoC heterogeneity of IP and inter-SoC heterogeneity of IP.

FIG. 2 illustrates hardware heterogeneity on an SoC. The figure shows several IPs integrated on the SoC. For example, a model A integrates a CPU and a GPU on the SoC; a model B integrates a CPU, a GPU, and an NE for neural network processing on the SoC; a model C integrates a CPU, a GPU, and an NPU for neural network processing on the SoC; a model D integrates a CPU, a GPU, a DLA for deep learning, and a programmable vision accelerator (PVA) on the SoC.

As can be seen from the figure, on the same SoC, there are different IPs, for example, for different purposes. Regarding the intra-SoC heterogeneity of IP, this is due to the increasing number of different types of IPs (especially for computing purposes) being integrated into the SoC for high efficiency. A new IP will continue to be introduced into the SoC. For example, a new type of IP for neural network processing has been widely introduced into recent mobile SoCs. Moreover, the number of processing units on the SoC continues to grow. For example, an SoC of a model A mainly consists of 10 processing units (2 large cores, 2 small cores, and a 6-core GPU); in a model B, the number of processing units is increased to 30 (2 large general-purpose cores, 4 small general-purpose cores, a 16-core neural engine, and a 5-core GPU).

With respect to the inter-SoC heterogeneity of IP, IPs that implement the same function on different SoCs may vary greatly, because for business reasons, one's own IP is always preferred. For example, as shown in (b), (c), and (d) in FIG. 2, the same function (such as neural network processing) points to different IPs. In an SoC of a model B, it is an NE; in an SoC of a model D, it is a DLA; and in an SoC of a model C, it is an NPU. In addition, many IPs for computing purposes have some generality for a certain domain (such as deep learning) or for certain types of operations, (such as GPUs with tensor operations).

Programming of IPs such as GPUs and NPUs for computing purposes may be implemented based on support from programming frameworks and vendors. For example, in order to accelerate neural network processing, application developers may directly use deep learning programming frameworks, such as PyTorch, TensorFlow, MXNet, etc., instead of direct manual management. These programming frameworks provide advanced programming interfaces (C++/Python) to customize IPs, which are implemented using low-level interfaces of IP vendors. IP vendors offer different programming interfaces, such as a parallel thread execution (PTX), a compute unified device architecture (CUDA), a CUDA deep neural network library (cuDNN), and a NVIDIA collective communications library (NVIDIA Collective Communications LibraryNCCL), to make their hardware drives suitable for these programming frameworks.

However, programming frameworks require extremely huge development efforts because they need to be able to bridge the gap between software diversity and hardware diversity. The programming frameworks provide application developers with advanced interfaces to improve programming productivity, and these interfaces are carefully implemented to improve hardware performance and efficiency. For example, Tensorflow is initially developed by approximately 100 developers and is currently maintained by over 3,000 contributors to support dozens of SoC platforms. For thousands of Tensorflow operators, optimizing one operator on a certain IP may take a skilled developer several months. Even with programming frameworks, for different SoCs, application developers may still be required to have different implementations. For example, a program written for a certain model D cannot run directly on the server-side DGX-1 of the TensorCore of the GPU.

The programming framework is difficult to achieve high efficiency. The root cause lies in the fact that the SoC is managed through the host CPU. Since the programming framework running on the host CPU controls the entire execution process, the interaction of control and data is inevitable. For the control, only CPU-IP interaction is used, and for the data exchange, only memory-IP interaction is used.

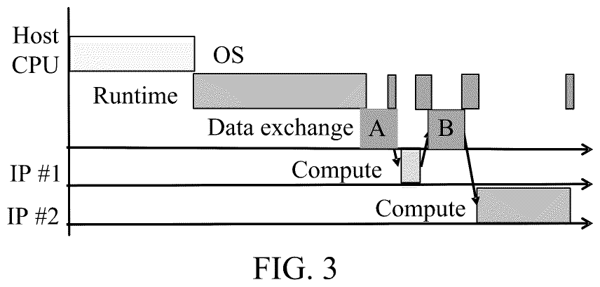

FIG. 3 illustrates a typical timeline of a traditional SoC. As shown in the figure, a host CPU runs a programming framework for runtime management, where every call to IP is started/ended by the host CPU, which imposes a non-negligible runtime overhead. Data is stored in an off-chip main memory, and IP reads/writes the data from the main memory, which brings additional memory access of data. For example, when running a neural network YOLO on a certain model D, control will be returned from the GPU to the programming framework 39 times, occupying 56.75M of DRAM space, of which 95.06% is unnecessary. According to Amdahl's Law, the efficiency of a system is limited, especially for programs composed of fragmented operations.

### Invention Conception

Considering that exposing hardware heterogeneity to management software may lead to low productivity and low hardware utilization, the present disclosure proposes a solution that enables SoC hardware to manage heterogeneity by itself. The inventors note that a classical CPU treats a heterogeneous arithmetic logic unit (ALU) and a heterogeneous float point unit (FPU) as execution units in the pipeline and manages them by hardware. Inspired by this, intuitively, IP may also be seen as an execution unit in an IP-level pipeline, which is a unified SoC-as-a-processor (SaaP).

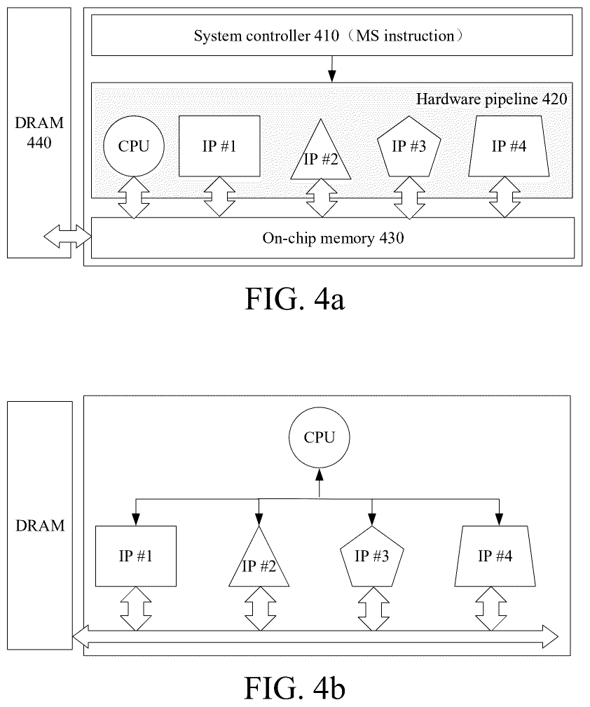

FIG. 4a illustrates an SaaP architecture according to an embodiment of the present disclosure using a simplified diagram. As a contrast, FIG. 4b shows a traditional SoC architecture, where a single line represents a control flow, and a broad line represents a data flow.

As shown in FIG. 4a, the SaaP of the embodiment of the present disclosure reconstructs an SoC into a processor, including: a system controller 410 (which is equivalent to a controller in the processor, in other words, a pipeline manager), where the system controller 410 is configured to manage a hardware pipeline, including fetching an instruction from a system memory (for example, a DRAM 440 in the figure), decoding the instruction, dispatching the instruction, quashing the instruction, submitting the instruction, and so on; and a plurality of heterogeneous IP cores, including CPU cores, which are integrated into the SoC as execution units (which are equivalent to operation units in the processor) in a hardware pipeline 420, where the plurality of heterogeneous IP cores are configured to execute the instruction dispatched by the system controller 410. As such, the SaaP may manage heterogeneous IP cores using a hardware pipeline rather than a programming framework.

Similar to a multiscalar paradigm, a program is divided into tasks, which may be as small as a single scalar instruction or as large as the entire program. A task may be implemented on various types of IP cores and is dispatched to a specific IP core when executed. These tasks are called instructions in the SaaP. Due to different sizes of the tasks, the embodiment of the present disclosure proposes a mixed-scale (MS) instruction to work in conjunction with an SaaP with an IP-level pipeline. The MS instruction is a unified instruction that may be applied to various heterogeneous IP cores. Therefore, hardware heterogeneity is transparent under the MS instruction. The MS instruction is performed by the system controller 410 for operations such as instruction fetching, decoding, dispatching, quashing, and submitting, and the like. The use of the MS instruction may take full use of mixed-level parallelism.

Furthermore, an on-chip memory 430 may also be provided for SaaP, such as an on-chip static random access memory (SRAM) or a register, which is configured to cache data related to the execution of the execution unit (IP core), such as input data and output data. Thus, after data on the system memory is transferred to the on-chip memory, the IP core may interact with the on-chip memory for memory access of data. The on-chip memory 430 is similar to a register in a processor, so on-chip IP collaboration may also be implicitly implemented in a manner similar to register forwarding in a multi-scalar pipeline.

In the hardware pipeline of SaaP, mixed-level parallelism may be fully utilized by using the MS instruction, and data exchange between IP cores may be achieved by using the on-chip memory, thereby obtaining high hardware performance. Moreover, SaaP allows any type of IP core to be integrated as an execution unit, and advanced code from application developers may be compiled to a new IP core with only slight adjustments, thereby enabling the improvement of programming productivity.

In contrast, a traditional SoC shown in FIG. 4b is CPU-centric and runs a programming framework on a host CPU. Various IP cores are attached as isolated devices to a system bus and are managed by software running on the host CPU. As can be seen from the figure, in a traditional SoC, there is only CPU-IP interaction for control flows; and there is only system memory (DRAM)-IP interaction for data flows.

In the SaaP, the SoC is constructed with an IP-level pipeline, and the IP core is managed as the execution unit. In this way, the control flows may naturally be managed by the pipeline manager, and no programming framework is required at runtime. Moreover, by using a mechanism similar to pipeline forwarding, data exchange may be performed directly among different IP cores.

Extending the CPU scalar pipeline to the IP-level pipeline inevitably faces many challenges. One challenge is consistency. Because heterogeneous IP cores such as DL accelerators access data (such as tensors and vectors) in blocks of various sizes instead of scalar data, checking data dependencies and maintaining data consistency become extremely complex as data blocks flow concurrently in the pipeline. As a result, register files, cache levels, and data paths all need to be fundamentally redesigned. Another challenge is scalability. According to Amdahl's Law, the overhead of IP collaboration (usually at the us level) unintentionally limits the scalability of traditional SoCs. This kind of overhead will also prevent sub-u s-level cores from utilizing IP, because this overhead may exceed the execution time. Moreover, for scalability, SaaP should not favor designs that are expensive in terms of time/area, such as chained squashing and crossbar.

Despite challenges from a plurality of aspects, the research of the inventors found that the root of the problem lies merely in the unclear ownership of shared data in the traditional design concept. In the traditional SoC, data may be accessed and modified by different IP cores at any time, and a plurality of data copies may exist. Therefore, in order to execute the program correctly, complex mechanisms with a large amount of overhead need to be introduced, such as bus snooping, atomic operations, transaction memory and address resolution buffers, to maintain data consistency and consistency of IP coordination.

To avoid the defects caused by unclear ownership of shared data, the SaaP SoC follows the principle of the pure exclusive ownership (PXO) architecture in its design. The principle is that data-related resources in the system, including on-chip buffers, data paths, data caches, memories, and input/output (I/O) devices, are monopolized by an IP core at a certain time. The SaaP architecture and its associated design provided in the embodiment of the present disclosure are described in detail below in conjunction with the attached drawings.

### Overall SaaP Architecture

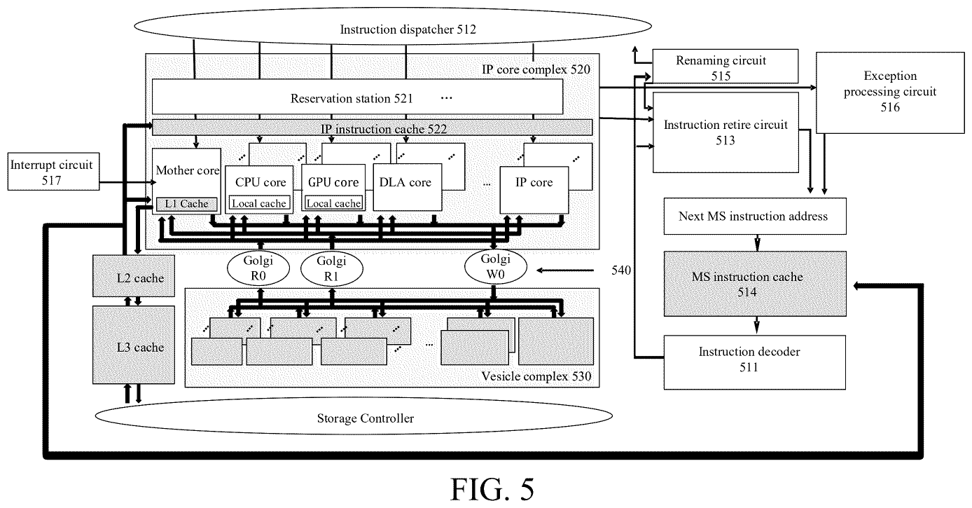

FIG. 5 illustrates an overall SaaP architecture according to an embodiment of the present disclosure. Similar to Tomasulo pipeline, SaaP may contain an out-of-order five-level pipeline.

As shown in the figure, in the SaaP, a system controller, as a pipeline manager, may include a plurality of functional components to implement different functions in the pipeline management process. For example, an instruction decoder 511 may decode MS instructions proposed in the embodiment of the present disclosure. An instruction dispatcher 512 may dispatch MS instructions. An instruction retire circuit 513 is configured to complete instruction submission and retire the completed MS instructions in sequence. An MS instruction cache 514 is configured to cache MS instructions. A renaming circuit 515 is configured to rename storage elements involved in the instruction to, for example, resolve possible data hazards. The system controller may achieve one or more of the following processing using a renaming mechanism: resolving data hazards on the storage elements, MS instruction quashing, MS instruction submission, and so on. An exception processing circuit 516 is configured to respond to the exception thrown by the IP core and perform corresponding processing. The functions of components are described in the relevant part of the present disclosure.

The integrated heterogeneous IP cores (the figure illustrates various IP cores such as a CPU core, a GPU core, a DLA core, and so on) act as execution units for performing actual operations. These heterogeneous IP cores and related components (such as a reservation station 521, an IP instruction cache 522, and so on) may be collectively referred to as an IP core complex 520.

On-chip memory is also provided in the SaaP. In some implementations, on-chip memory may be implemented as a bunch of scratchpads (also known as a set of vesicles) for buffering input data and output data. The vesicles act as registers in the processor. The vesicles may include a plurality of scratchpads with unequal storage capacities for caching data related to executions of a plurality of heterogeneous IP cores. For example, capacity sizes of the vesicles may range from 64 B, 128 B, 256 B, . . . 256 KB, up to 512 KB. Preferably, the number of small-capacity vesicles is greater than that of large-capacity vesicles to better support task requirements of different scales. This set of vesicles may be collectively referred to as a vesicle complex 530.

Between the vesicle complex 530 and the IP core complex 520, an on-chip interconnection 540 is provided to offer non-blocking data path connections between a plurality of heterogeneous IP cores and a set of vesicles. The on-chip interconnection acts as a shared data bus. In some embodiments, the on-chip interconnection 540 may be implemented based on a sorting network, thus providing a non-blocking data path with only a small amount of hardware cost and acceptable latency. In the present disclosure, the on-chip interconnection 540 may also be referred to as Golgi.

As mentioned earlier, the SaaP SOC follows the principle of the PXO architecture in its design. To this end, in some embodiments, among the plurality of heterogeneous IP cores mentioned above, one IP core may be designated as a mother core to be responsible for managing the entire system. For example, the mother core exclusively manages the data exchange between the system memory and the vesicles. The mother core also exclusively manages the I/O operations between the system and external devices. The mother core may also control an operating system (OS) and runtime, and be responsible for at least one or more of the following processing: process management, page management, exception processing, and interrupt processing. For example, in branch and prediction executions, the branch and prediction executions are implemented through exception processing, where an unlikely branch is treated as an unlikely branch exception (UBE). Static prediction may be used to implement the branch and prediction executions. Taking into account the role and function of the mother core, the CPU core with general processing functions is usually determined as the mother core. In some embodiments, it is preferred to enhance the I/O capability of the mother core, for example by introducing a direct memory access (DMA) unit to alleviate the pressure of continuous data replication.

In some embodiments, IP cores other than the mother core may be divided into different IP lanes according to their functions and/or types. The mother core itself belongs to a separate IP lane. FIG. 5 shows a mother core lane, a CPU lane, a CPU lane, a DLA lane, and so on. Then, when scheduling MS instructions, at least partially based on task types of the MS instructions, they may be dispatched to appropriate IP lanes.

In general, SaaP uses MS instructions to execute the entire program. Initially, when the system controller fetches an MS instruction back, the system controller decodes the MS instruction to prepare data for execution. The data is loaded from the system memory into the vesicles or quickly forwarded from other vesicles. If there is no conflict, the MS instruction is transmitted to the MS instruction dispatcher and then to the appropriate IP core (for example, a DLA core) for actual execution. This IP core loads pre-compiled actual IP-specific code (for example, a DLA instruction) based on the MS instruction transmitted. After that, the IP core executes the actual code, which is very similar to the execution on a regular accelerator. After the execution is completed, the MS instruction retires from the pipeline and submits its results.

The overall architecture and task execution process of the SaaP SoC in the embodiment of the present disclosure are summarized above. The implementation of each part is described in detail below. It is understood that although the implementation of each part is described in the SaaP SoC environment, these parts may also be applied independently of the SaaP SoC to other similar environments, such as non-heterogeneous systems. The present disclosure embodiment has no restrictions in this regard.

### MS Instruction

The heterogeneity in hardware is manifested in the interface between software and hardware as the difference in instruction formats, and the number of execution cycles of each instruction (cycle per instruction, CPI) also varies greatly. Table 1 shows the comparison among different instruction sets. For scalar systems, two types of instruction sets are usually included: complex instruction set computer (CISC) and reduced instruction set computer (RISC). As shown in the table, a length of each instruction in CISC is uncertain, some instructions have complex functions and more beats, and some instructions have simple functions and fewer beats. Depending on the complexity of the execution of a single instruction, the CPI ranges from 2 to 15 beats. The instruction length of RISC is fixed, and the CPI for a single instruction is relatively uniform, approximately ranging from 1 to 1.5 beats.

Due to the heterogeneity of SaaP SoC, the instruction sets required by various IP cores (including CPUs and various xPUs) on it are different, such as in terms of scale or granularity. In order to hide this heterogeneity (for example, instruction format, CPI, and the like), a mixed-scale instruction set computer (MISC) similar to RISC in form is provided in some embodiments of the present disclosure, which may be adapted to various IP cores. Most of these IP cores (mainly various accelerators for computing purposes) need to handle some complex tasks with large granularity efficiently, so the CPI of a single MS instruction is greater than that of RISC, ranging from 10 to 10000+ beats, which falls within a relatively large range. The MISC provided by the embodiment of the present disclosure is also shown in Table 1.

TABLE 1
Comparison of different instruction sets

| | CISC | RISC | MISC |
|---|---|---|---|
| Meaning | Complex | Reduced | Mixed-scale |
| ISA | Simple + macro | Simple | Function/functional |
| feature | instruction | | |
| Execution | Scalar(w/SIMD) | Scalar(w/SIMD) | IP |
| unit | | | |
| Pipeline | ILP | ILP | Mixed |
| granularity | | | |
| CPI | 2~15 | ~1.5 | 10~10000+ |

Each instance of SaaP is an MISC. The MISC instruction set consists of MS instructions. Different from RISC and CISC, the MISC has its own unique design style.

First, the MS instruction has a mixed load size. It may be a relatively small load, for example, only requiring 10 beats to be executed, or a relatively large load, for example, requiring over 10,000 beats to be executed. Therefore, the load carried by each MS instruction may require containers of different sizes to facilitate fetching data from the containers and storing the computed result data into the containers. In the embodiment of the present disclosure, a set of vesicles of various sizes (for example, from 64 B to 512 KB) mentioned above is used to store input and/or output data required by the MS instruction, thereby supporting this mixed load size of the MS instruction.

Moreover, the MS instruction is IP independent, in other words, the MS instruction is not aware of IP. Specifically, each IP core specific instruction (for example, a heterogeneous instruction) is encapsulated in the MS instruction, and the encapsulated MS instruction format is not related to which IP core is specifically encapsulated.

In some embodiments, the MS instruction may include a sub-instruction domain, where the sub-instruction domain indicates sub-instruction information specific to one or a plurality of IP cores capable of executing the MS instruction. It may be understood that the MS instruction needs to run on a certain IP core in the future, which means that there is a piece of code that may be identified by this IP core (in other words, IP core specific code). These codes are also composed of one or a plurality of IP core specific instructions. These instructions are encapsulated in the MS instruction and are therefore called sub-instructions. Thus, the system controller may dispatch the MS instruction to the corresponding IP core according to the sub-instruction domain. The sub-instruction information may contain types of sub-instructions (in other words, types of IP cores or types of IP lanes) and/or addresses of sub-instructions. The sub-instruction information may be represented in a variety of implementations.

In an implementation, addresses of sub-instructions specific to one or a plurality of IP cores may be placed into the sub-instruction domain. This approach may directly determine the types and addresses of the sub-instructions in the MS instruction. However, in this implementation, since the same MS instruction may be able to run on a plurality of heterogeneous IP cores, the length of the MS instruction varies with the number of IP core types that may run the MS instruction.

In another implementation, a bit sequence may be used to represent whether the MS instruction has a corresponding type of sub-instruction, and at the same time, a starting address may be used to represent the first segment of the sub-instruction address. The length of the bit sequence may be the number of IP core types or IP lane types, so that each bit in the bit sequence may be used to indicate whether there is a corresponding type of sub-instruction. The first segment of the sub-instruction address is directly obtained based on the starting address. The sub-instruction addresses corresponding to the subsequent IP lanes may be indexed in a fixed way (for example, at intervals of a certain address distance), or achieved by directly jumping to the MS instruction. The embodiment of the present disclosure has no restrictions on the specific format implementation of the MS instruction.

The MS instruction is defined to perform complex functions. Thus, each MS instruction performs a complex function, such as convolution. This instruction will be decomposed into fine-grained IP-specific code (in other words, sub-instructions) for actual execution, such as RISC instructions. The IP-specific code may be code compiled based on a standard library (for example, std::inner_product, which is used for inner product operations and comes from Libstdc++). The IP-specific code may also be code generated based on a vendor-specific library (for example, CublasSdot, which is also used for inner product operations and comes from cuBLAS). This makes it possible for SaaP to integrate different types of IPs, as the same MS instruction may be flexibly transmitted to different types of IP cores. As a result, heterogeneity is hidden for application developers, which also increases the robustness of SaaP.

As can be seen from the above, no matter which IP core the sub-instruction is used for, such as CPU, GPU, DLA, NPU, etc., it will not change the format of the MS instruction. Therefore, from this perspective, the MS instruction is IP independent.

Then, the MS instruction has a limited arity. For data management, each MS instruction will access up to three vesicles: two source vesicles and one destination vesicle. In other words, for data management, each MS instruction has at most two input data domains and one output data domain, which are used to indicate data information related to the execution of the MS instruction. In some implementations, these data domains may be represented through serial numbers of the associated vesicles, for example, indicating two input vesicles and one output vesicle respectively. The limited arity reduces the complexity of conflict resolving, renaming, data path design, and compiler tool chains. For example, if the arity of the MS instruction is not limited, the decoding time differences of different MS instructions may be very large, which leads to an irregular hardware pipeline and some inefficient problems. For functions/operations with high arity (for example, more than 3), currying may be applied. Currying is a technique of converting multivariate functions into sequences of univariate functions, such as through nesting, linking, and other methods. Thus, operations/functions with any number of inputs and outputs may be supported to be converted into operations/functions with limited arities that satisfy MS instructions.

Finally, the MS instruction has no side effects. “No side effects” means that the execution state of the current instruction does not affect the executions of subsequent instructions. In other words, if the current instruction is to be quashed, the current instruction may be quashed without allowing its residual state to affect the executions of subsequent instructions. Except for modifying the data in the output vesicle, the execution of the MS instruction does not leave any observable side effects on the SaaP architecture. The only exception is the MS instruction executed on the mother core, as the master core may operate on the system memory and external devices. This constraint is very important for achieving mixed level parallelism (MLP), because it enables the simple rollback of the impact when, for example, according to the requirements of prediction execution, the MS instruction needs to be quashed. In other words, the data domain of the MS instruction executed on the IP core other than the mother core may only point to the vesicle, but not to the system memory. Moreover, the vesicle corresponding to the output data is exclusively dispatched to the IP core executing the MS instruction.

It may be seen from this that by providing a new MS instruction set and making a unified abstraction at the software and hardware interface, the heterogeneity between different hardware or different instructions may be hidden, so that a unified MS instruction format may be seen at the hardware level. These MS instructions may be distributed to different IP cores for actual execution.

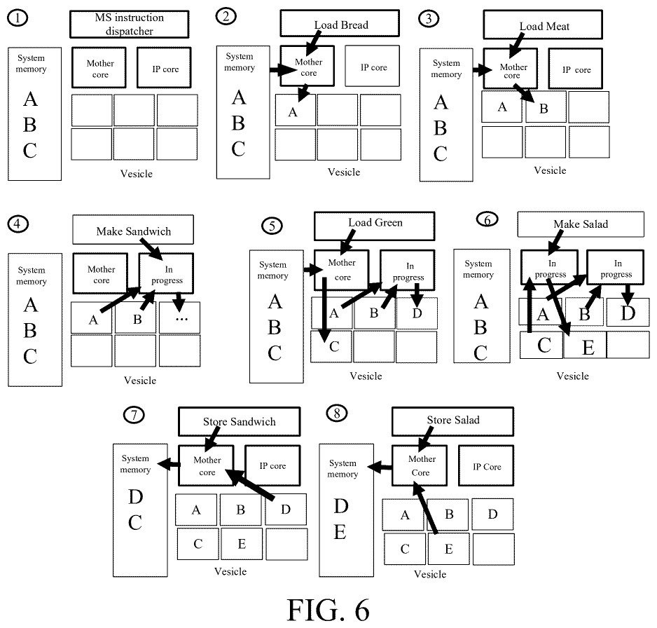

FIG. 6 shows an example process of performing tasks on the MISC architecture to better understand the implementation solution of the MS instruction. The illustrated MISC architecture, for example, has one mother core and one IP core. The task to be executed is to make a sandwich (ingredients: bread and meat) and a green salad (ingredients: green). For the convenience of drawing, in FIG. 6, the bread is named A, the meat is named B, the green is named C, the sandwich is named D, and the salad is named E. The mother core manages the system memory, so the mother core first loads the material to be processed from the system memory to the vesicle, and then the IP core may process the material on the vesicle. The above task may be represented as following MS instruction streams:
1) “Load Bread” v1, void, void
2) “Load Meat” v2, void, void
3) “Make Sandwich” v1, v1, v2
4) “Store Sandwich” void, v1, void
5) “Load Green” v1, void, void
6) “Make Salad” v1, v1, void
7) “Store Salad” void, v1, void

It may be understood that when MS instructions are executed on both the mother core and the IP core, specific code forms for each core should be provided, in other words, specific sub-instructions for each core, so that each core may know how to perform corresponding tasks. For the sake of simplicity, these sub-instructions only simply show their processing tasks or functions in the above MS instruction stream, without distinguishing different forms. The vesicles (v1, v2) used in the MS instruction are logical numbers. In actual execution, the vesicles are renamed to different physical numbers to address write after write (WAW) dependency and support out-of-order prediction execution. The Void in the instruction indicates that the corresponding domain does not require the vesicle, for example when the system memory is involved.

In FIG. 6, \textcircled{1} is an initial state; \textcircled{2} indicates that the mother core performs the MS instruction “Load Bread”. The Load instruction involves access to the system memory and is therefore dispatched to the mother core for execution. The mother core fetches data from the system memory and stores it in the vesicle v1. The memory access address information of the system memory specifically involved may be placed in an additional instruction domain. The embodiment of the present disclosure has no restrictions in this regard. \textcircled{3} indicates that the mother core performs the instruction “Load Meat”. Similar to the instruction “Load Bread”, the mother core fetches data from the system memory and stores it in the vesicle v2.

Then, \textcircled{4} is to perform the instruction “Make Sandwich”. This MS instruction is dispatched to the IP core for processing because it requires a considerable amount of processing time. According to the original instruction, the IP core needs to fetch the bread from the v1, fetch the meat from the v2, and put them into the v1 after making. Here, since the v1 to be written to and the v1 to be read out are the same, there exists a write after read (WAR) correlation, in other words, the data in the v1 must be completely read out before writing. However, this approach is not very realistic because the MS instruction may be extremely large, for instance, requiring tens of thousands of beats, and the sandwich made in the middle needs a place to be stored. To resolve this data hazard, a vesicle renaming mechanism may be adopted. For example, before the MS instruction is dispatched, the logical name of the vesicle in the MS instruction is renamed and mapped to the physical name through a vesicle renaming circuit 515 shown in FIG. 5 to eliminate the data hazard. At the same time, the vesicle renaming circuit 515 saves the mapping between the physical name and the logical name. In the example in FIG. 6, the vesicle v1 corresponding to the output data of the instruction “Make Sandwich” is renamed to the vesicle v3, so the made sandwich is placed in the v3. The ellipsis in the v3 in FIG. 6 indicates that this writing process will take some time and will not be completed quickly.

In \textcircled{5}, since making the sandwich takes a lot of time, the subsequent instruction “Store Sandwich” cannot be executed yet. However, the subsequent instruction “Load Green” has no dependency on the previous one and may therefore be executed in parallel. Similarly, the vesicle v1 involved in the instruction “Load Green” also involves a WAR correlation. Therefore, the vesicle renaming mechanism may be adopted to rename and map the corresponding vesicle v1 to the vesicle v4. Similarly, the mother core executes the instruction “Load Green” and fetches the data in the system memory and writes it into the vesicle v4.

In \textcircled{6}, the IP core has been occupied to make the sandwich, so in order to improve efficiency, the instruction “Make Salad” may be dispatched to the currently idle mother core according to the scheduling policy. The state of each core, for example, may be marked by a bit sequence to facilitate the dispatch of instructions by the instruction dispatcher. Again, the renaming mechanism is used here. The mother core fetches the green from the vesicle v4 and puts them into the vesicle v5 after making the green into the salad.

In \textcircled{7}, when the sandwich is made, the previously blocked instruction “Store Sandwich” may be executed at this time. The instruction “Store” involves access to the system memory and is therefore dispatched to the mother core for execution. The mother core fetches the data from the vesicle v3 and stores it in the system memory.

In \textcircled{8}, when the salad is made, the instruction “Store Salad” may be executed. The mother core fetches the data from the vesicle v5 and stores it in the system memory.

It should be noted that in \textcircled{7} and \textcircled{8}, even if the salad is made before the sandwich, the instruction “Store Salad” needs to be executed after the instruction “Store Sandwich” to ensure sequential submission. Thus, there will be no side effects when the instruction is quashed.

It may be seen from the above exemplary process that when the data is ready, the IP core may start to perform processing. “Make Sandwich” takes a considerable amount of time. Therefore, “Make Salad” is executed on the mother core and completed ahead of schedule, thereby fully exploring the MLP. As a result, the execution between different IP cores does not interfere with each other, in other words, they may be executed out of order, but they are submitted sequentially.

### System Controller

The processing between MS instructions or within the instructions themselves is uniformly managed by the system controller (also known as the instruction processing apparatus). Functions of each component of the system controller are described below in detail. SaaP SoC adopts out-of-order pipelines to explore the MLP among IP cores. The pipeline may contain 5 levels: fetching & decoding, conflict resolving, dispatching, executing, and retiring.

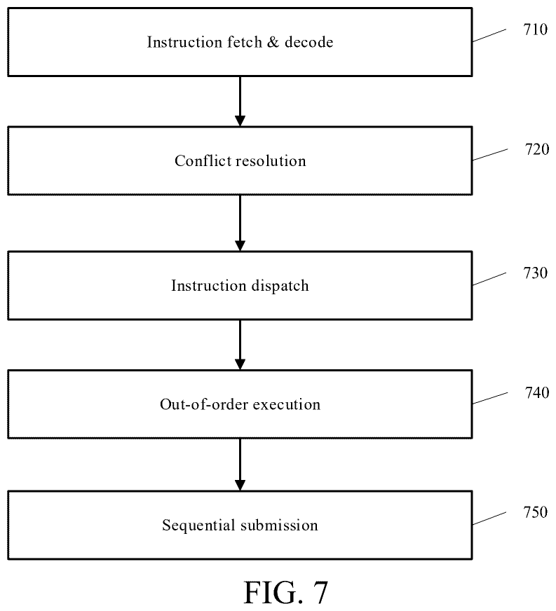

FIG. 7 illustrates an exemplary flowchart of an instruction execution method according to an embodiment of the present disclosure. The following description may be understood by referring to the SaaP architecture shown in FIG. 5 simultaneously. In addition, for ease of description and understanding, FIG. 7 shows an instruction execution process with a complete pipeline, but those skilled in the art may understand that some steps may occur only in certain cases and are therefore not necessary in all cases, and the necessity may be identified according to the specific situation.

First, in step 710, instruction fetch & decode are performed. At this level, the MS instruction is fetched from the MS instruction cache 514 based on the MS program counter (PC), and the instruction decoder 511 decode the fetched MS instruction to prepare the operand. The decoded MS instruction may be placed in the instruction queue of the instruction decoder 511.

As described earlier, the MS instruction includes a sub-instruction domain, which indicates sub-instruction information specific to one or a plurality of IP cores capable of executing the MS instruction. The sub-instruction information, for example, may indicate types of sub-instructions (for example, types of IP cores or types of IP lanes) and/or addresses of sub-instructions.

In some embodiments, when the MS instruction is fetched and decoded, the corresponding sub-instruction may be fetched in advance and stored in a specified location, such as the sub-instruction cache 522 (also known as the IP instruction cache in FIG. 5), according to the decoding result. Thus, when the MS instruction is transmitted to the corresponding IP core for execution, the IP core may fetch the corresponding sub-instruction from the sub-instruction cache 522 for execution.

In some cases, the MS instruction may be a branch instruction. In the embodiment of the present disclosure, static prediction is used to determine the direction of the branch instruction; in other words, static prediction is used to determine the PC value of the next MS. The inventors have analyzed the branch behavior in the benchmark test program and found that 80.6%~99.8% of the large-scale instruction branches may be correctly predicted at compile time. Since large-scale instructions determine the overall execution time, in the embodiment of the present disclosure, static prediction is adopted to perform branch prediction, thereby eliminating the need for a hardware branch predictor. Therefore, whenever a branch is encountered, it is always assumed that the next MS instruction is the statically predicted likely branch direction.

When a branch is wrongly predicted, an unlikely branch exception (UBE) is triggered. When an exception occurs, the incorrect MS instruction needs to be quashed, the next MS instruction count is set to an unlikely branch of the UBE, or in other cases, an exception trap occurs. The processing solution for branch and prediction executions is described in detail in the following sections.

Next, the pipeline advances to step 720, where possible conflicts are resolved. At this level, the fetched MS instructions are queued to resolve the conflicts. Possible conflicts include (1) data hazard; (2) structural conflict (for example, there is no available space in the retiring unit); and (3) exception violation (for example, blocking an MS instruction that may not be easily quashed until the MS instruction is confirmed to be taken).

In some embodiments, data hazards such as read after write (RAW) and write after write (WAW) may be resolved through the vesicle renaming mechanism. The vesicle renaming circuit 515 is configured to rename and map the logical name of the vesicle to the physical name of the vesicle and to save the mapping between the physical and logical names of the vesicle before dispatching the MS instruction when there is a data hazard on the vesicle involved in the MS instruction. Through the vesicle renaming mechanism, SaaP may support faster MS instruction quashing (achieved by simply discarding the renaming and mapping of the vesicle of the output data) and out-of-order execution without WAW hazards.

After resolving possible conflicts, the pipeline advances to step 730, where the MS instruction is dispatched by the instruction dispatcher 512.

As described earlier, the MS instruction includes the sub-instruction domain, which indicates the IP core capable of executing the MS instruction. Therefore, the instruction dispatcher 512, based on the information of the sub-instruction domain, may dispatch the MS instruction to the corresponding IP core. Specifically, the instruction dispatcher 512 may first dispatch the MS instruction to the reservation station that the IP core belongs to for subsequent transmission to the appropriate IP core.

In some embodiments, IP cores may be divided into different IP lanes based on their functions and/or types, with each lane corresponding to a specific IP core model. Correspondingly, reservation stations may also be grouped according to the lanes, for example, each lane corresponding to one reservation station. For example, a mother core lane, a CPU lane, a CPU lane, a DLA lane, and so on, are shown in FIG. 5. Different lanes may be used to perform different types of tasks. Therefore, when the MS instruction is scheduled and dispatched, the MS instruction may be dispatched at least partly based on the task type of the MS instruction to the reservation station corresponding to the appropriate lane for subsequent transmission to the appropriate IP core.

In some embodiments, in addition to considering the task type, scheduling may also be performed among a plurality of IP lanes capable of executing the MS instruction based on the processing state in each IP lane, thereby improving processing efficiency. Since the same MS instruction may have a plurality of different implementations executed on a plurality of IP cores, the processing pressure of the bottleneck lane may be alleviated by selecting the dispatched lane according to the appropriate scheduling policy. For example, MS instructions involving convolution operations may be dispatched to the GPU lane or the DLA lane. The MS instructions may be executed efficiently in both lanes. At this point, one of the two lanes may be selected according to the pressure of the two lanes, thus speeding up the processing progress. The scheduling policy may include various rules, such as selecting the IP core with the highest throughput, or selecting the IP core with the least number of sub-instructions, etc. The embodiment of the present disclosure has no limitations in this respect.

In some embodiments, some specified types of MS instructions must be dispatched to the specified IP cores. For example, as mentioned earlier, among a plurality of heterogeneous IP cores, one IP core may be designated as the mother core to be responsible for managing the entire system. Therefore, some MS instructions involving system management must be dispatched to the mother core for execution.

Specifically, the mother core exclusively manages the data exchange between the system memory and the vesicle. Therefore, a memory access-type MS instruction that accesses the system memory is dispatched to the mother core. The mother core also exclusively manages the I/O operations between the system and external devices. Therefore, an I/O-type MS instruction such as display output is also dispatched to the mother core. The mother core may also control the operating system (OS) and runtime, and be responsible for at least one or more of the following processing: process management, page management, exception processing and interrupt processing, etc. Therefore, MS instructions for processing interrupts by the interrupt circuit 517 are dispatched to the mother core. In addition, when some MS instructions may not be processed by other IP cores, for example, because other IP cores are busy, the MS instructions may be dispatched to the mother core for processing. In addition, according to the MS instruction scheduling policy, some MS instructions may be dispatched to the mother core for processing. Here, no detailed examples will be listed.

Next, the pipeline advances to step 740, where the MS instruction may be executed out of order by the IP core.

Specifically, the IP core dispatched to the instruction may utilize the actual IP-specific code to perform the function of the MS instruction. For example, according to the dispatched instruction, the IP core fetches the corresponding sub-instruction from the sub-instruction cache/IP instruction cache 522 and executes it. Tomasulo algorithm may be implemented at this stage to organize these IP cores, thereby supporting the MLP. Once the correlation on the vesicle is resolved, the MS instruction may be continuously dispatched into the IP core complex, so that these instructions may be executed out of order.

In the SaaP SoC provided by the embodiment of the present disclosure, the IP core is not aware of the SaaP architecture because intrusive modifications to the IP core are prohibited. To adapt to SaaP, the IP core is encapsulated using an adapter. The adapter directs the access to the program to the IP instruction cache 522 and the access to the data to the vesicle. The program may be an interface signal of an accelerator, for example, a configuration space bus (CSB) control signal used for DLA, or a piece of IP-specific code for implementing the MS instruction (for example, for a programmable processor such as a CPU/GPU). An operation-type MS instruction performs operations on data stored in a set of vesicles. These vesicles may be a plurality of scratchpads with unequal storage capacities. Each IP core has two data read ports and one data write port. During execution, the physical vesicle is exclusively connected to the port. Therefore, from the perspective of the IP core, the vesicle works just like a main memory in a traditional architecture.

Finally, the pipeline advances to step 750, which is a retiring stage. At this stage, the MS instruction retires from the pipeline, and the result is submitted. The instruction retire circuit 513 in FIG. 5 is configured to retire the completed MS instructions in sequence and submit the execution result by confirming the renaming mapping of a vesicle corresponding to output data of the MS instruction when the instruction is retired. In other words, the submission is completed by permanently recognizing the renaming and mapping of the vesicle of the output data in the renaming circuit 515. Since only the renaming and mapping are recognized, no data is actually buffered or copied, thus avoiding the additional overhead caused by replicating data when the data volume is large (which is very common in various IP cores for computing purposes).

It should be understood that although the execution process of the MS instruction is described in the SaaP SoC environment, the MS instruction system may also be applied in other environments, not limited to those with heterogeneous IP cores. For example, it may also be used in a homogeneous environment, as long as the execution unit of the MS instruction may independently parse and execute sub-instructions. Therefore, in the description above, the IP core may be directly replaced with the execution unit, and the mother core may be replaced with the master execution unit. The above methods still apply.

### Branch and Prediction Executions

Branch instructions may also occur in the MS instruction stream, and branch instructions cause control correlation. The control correlation is actually a correlation with the PC of the MS instruction, and the PC value is used when the instruction is fetched. If the branch instruction is not processed well, the fetching of the next instruction will be affected, which will cause the blockage of the pipeline and affect the efficiency of the pipeline. Therefore, effective branch prediction support needs to be provided for MS instructions; in other words, it is effective for both large-scale instructions and small-scale instructions.

In the traditional processing method of the CPU, the branch conditions are computed during decoding, and then the correct branch target is determined. Thus, the next instruction is fetched from the address of the branch jump position when the instruction is fetched in the next beat. This kind of branch condition computation and setting the next PC value to the value of the correct branch target usually only require a few beats of overhead. This part of the overhead is very small and may be completely offset by the pipeline in a regular CPU instruction pipeline. However, in the MS instruction stream, if a branch MS instruction is predicted incorrectly, it means that at some point during the entire execution process of the MS instruction stream, it is found that the branch MS instruction is predicted incorrectly. At this point, the position of this time point may be several hundred beats, several thousand beats or even longer away from the time when the branch MS instruction begins to execute. Therefore, in the MS instruction pipeline, it is impossible to determine the PC value of the next MS instruction only when it is truly known when to jump. In this case, the overhead of the prediction may be very large.

The inventors have analyzed branch behaviors in five benchmark test programs and found that 80.6%~99.8% of the large-scale instruction branches may be correctly predicted at compile time; in other words, the instruction branches may be predicted statically. Since large-scale instructions occupy the majority of the total execution time and determine the overall execution time, in the embodiment of the present disclosure, static prediction is adopted to perform branch prediction, thereby eliminating the need for a hardware branch predictor.

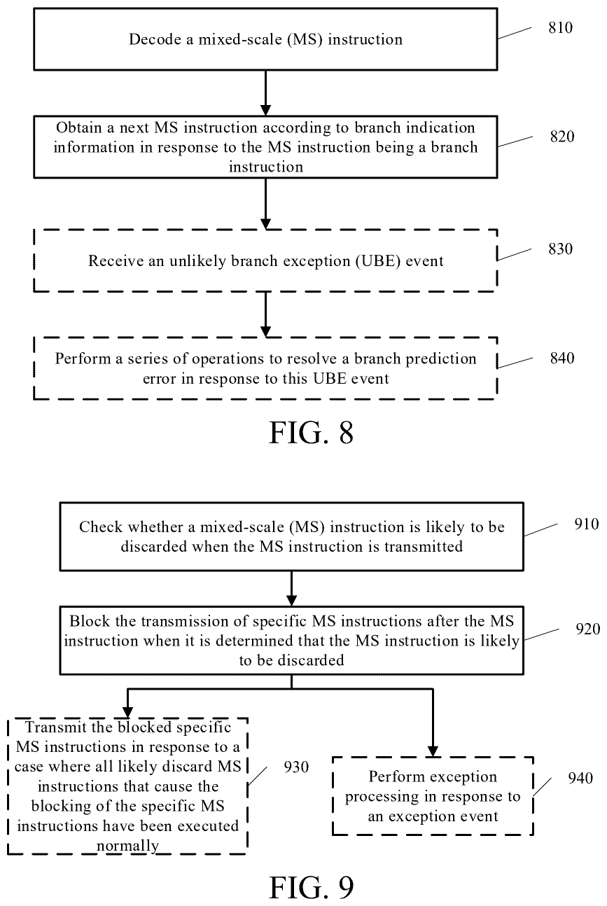

FIG. 8 illustrates an exemplary flowchart of an instruction execution method for a branch instruction according to an embodiment of the present disclosure. This method is performed by a system controller.

As shown in the figure, in step 810, an MS instruction is decoded. The MS instruction has a variable CPI. As described above, the range of the CPI of the MS instruction may be from 10 beats to over 10,000 beats. The variable CPI of the MS instruction also makes it difficult to use dynamic prediction.

Next, in step 820, a next MS instruction is obtained according to branch indication information in response to the MS instruction being a branch instruction, where the branch indication information indicates a likely branch target and/or an unlikely branch target.

Through a static prediction mechanism, static prediction may be carried out by using the prompts of the compiler. Specifically, during instruction compilation, the branch indication information may be determined based on the static branch prediction method and inserted into the MS instruction stream.

Depending on different static branch prediction methods, the branch indication information may contain different contents. For example, the static prediction always takes the likely branch target as the address of the next MS instruction. In some cases, in order to ensure the temporal locality of the instruction cache, the likely branch target may usually be adjacent to the current MS instruction. Therefore, in these cases, the branch indication information may only need to indicate the unlikely branch target. In some cases, the branch indication information may also indicate both the likely branch target and the unlikely branch target simultaneously. Therefore, when the next MS instruction is obtained according to the branch indication information, the likely branch target indicated by the branch indication information may be determined as the next MS instruction.

Since it is a prediction, there may be mistakes. When a branch prediction error occurs, all instructions following the branch instruction need to be quashed. The more pipeline levels there are, the more instructions that need to be quashed due to the branch prediction error there are, and the greater the efficiency loss of the instruction pipeline will be. Since the MS instruction adopts a static prediction method, before the branch condition is determined, the next MS instruction is taken in the inherent way. These instructions may be executed out of order, but they must be submitted in the order described earlier. Therefore, when the prediction direction of the branch instruction is found to be incorrect, it is necessary to restore to the correct next MS instruction. At this point, it is necessary to implement it through an exception mechanism to correct incorrect predictions.

Optionally or additionally, in step 830, when a prediction error occurs, the system controller receives the UBE event. The UBE event is triggered by an execution unit (such as a certain IP core) that executes the conditional computation instruction associated with the branch instruction. This UBE event indicates that according to the conditional computation, the branch direction should be the unlikely branch target; in other words, there is an error in the previous branch prediction.

At this time, in step 840, the system controller needs to perform a series of operations to resolve a branch prediction error in response to this UBE event. These operations include: quashing MS instructions after the branch instruction; submitting MS instructions before the branch instruction; and determining the unlikely branch target indicated by the branch indication information as the next MS instruction. This processing corresponds to a precise exception; in other words, when an exception occurs, all instructions before the instruction interrupted by the exception are executed, while all instructions after the instruction are as if they are not executed at all. Since the UBE event is an exception caused by a branch prediction error, the instruction interrupted by the exception mentioned above is the branch MS instruction.

Different operations may be adopted to achieve quashing based on different states of the MS instructions that need to be quashed. The MS instructions that need to be quashed are usually in three states: being executed in the execution unit; having already completed; or not yet executed. Different states may have an impact on different software and hardware, so these influences need to be eliminated. For example, if the instructions are being executed in the execution unit, the execution unit that is executing these MS instructions that need to be quashed needs to be terminated; if the instruction has performed a write operation on a scratchpad (such as a vesicle) during or after its execution, the scratchpad that has been written by the MS instruction to be quashed needs to be discarded. If the instruction is not executed yet, it only needs to be quashed from the instruction queue. Of course, since the instruction queue records all instructions that are not retired/submitted, instructions that are being executed or have already completed also need to be quashed from the instruction queue.

Therefore, in some embodiments, quashing the MS instructions after the branch instruction includes: quash these quashed MS instructions from the instruction queue; terminating the execution unit that executes these quashed MS instructions; and discarding the scratchpad that has been written by these quashed MS instructions.

As can be seen from the instruction retire process described in the previous text that when the MS instruction is retired, the execution result is submitted by confirming the renaming and mapping of the vesicle corresponding to the output data of the MS instruction. Therefore, when the scratchpad that has been written by these quashed MS instructions is discarded, it is only necessary to delete the corresponding mapping from the record that holds the renaming and mapping between the physical names and logical names of these scratchpads. As mentioned earlier, through this vesicle renaming mechanism, faster MS instruction quashing may be supported, and only the renaming and mapping of the vesicle of the output data needs to be simply discarded.

Therefore, in the MS instruction pipeline, processing branch MS instructions through static prediction may save hardware resources, adapt to the CPI characteristic of the MS instruction with a large variation range at the same time, and improve the pipeline efficiency. Furthermore, processing branch prediction errors through the exception mechanism may further save hardware resources and simplify processing.

### Exception and Interrupt Processing

As can be seen from the previous branch prediction processing, the cost of quashing large-scale MS instructions may be very high. Therefore, in the embodiment of the present disclosure, an instruction execution solution is proposed, which may block MS instructions that may cause high quashing costs until all instructions that is likely to be discarded before the instruction have been executed, i.e. the state has been determined. This instruction execution solution may significantly improve the processing efficiency of the MS instruction pipeline in exception and interrupt processing.

FIG. 9 illustrates an exemplary flowchart of an instruction execution method according to an embodiment of the present disclosure. This method is performed by a system controller.

As shown in the figure, in step 910, whether an MS instruction is likely to be discarded is checked when the MS instruction is transmitted.

In some embodiments, checking whether the MS instruction may be discarded includes checking whether the MS instruction has a likely discard label. The likely discard label may be inserted by a compiler at compile time based on the type of the MS instruction. For example, when the compiler discovers that the MS instruction is a conditional branch instruction or that other exceptions may occur, the likely discard label may be inserted.

Then, in step 920, the transmission of specific MS instructions after the MS instruction is blocked when it is determined that the MS instruction may be discarded.

The specific MS instructions may be those large-scale MS instructions, or MS instructions that usually have a relatively high quashing cost. Specifically, the specific MS instructions may be judged by one or more of the following conditions: MS instructions whose output data corresponds to a scratchpad (vesicle) whose scale is greater than a set threshold; MS instructions that perform write operations on the system memory; MS instructions whose execution duration exceeds a predetermined value; and MS instruction executed by a specific execution unit. When the scale (capacity size) of the vesicle corresponding to the output data is greater than the set threshold, it indicates that the amount of the output data of the MS instruction is relatively large, and the corresponding quashing cost is also high. Blocking the MS instructions that write to the system memory is mainly to ensure storage consistency.

After these specific MS instructions are blocked, their previous MS instructions are still transmitted and executed normally. According to the possible situations that may occur during the normal transmission and execution of these MS instructions, they may be dealt with separately.

On the one hand, in step 930, when all likely discard MS instructions that cause the blocking of the specific MS instructions have been executed normally, in response to this event, the blocked specific MS instructions may be transmitted for execution by the execution unit. Understandably, at this point, it may be determined that this specific MS instruction will not be quashed due to the previous instructions, so the normal transmission and execution of the instruction pipeline may continue.

On the other hand, in step 940, when an exception occurs in the execution of any likely discard MS instruction that causes the blocking of the specific MS instructions, exception processing is performed in response to this exception event. Similarly, this kind of exception processing corresponds to a precise exception. The MS instruction that causes the exception and the subsequent MS instructions are required to be quashed, and the MS instructions before the MS instruction are required to be submitted; and the MS instruction of the corresponding exception processing program is used as the next MS instruction.

Similar to the description in the previous branch prediction processing, quashing the MS instruction that causes the exception and the subsequent MS instructions includes: quashing these quashed MS instructions from the instruction queue; terminating the execution unit that executes these quashed MS instructions; and discarding the scratchpad that has been written by these quashed MS instructions. Similarly, discarding the scratchpad that has been written by these quashed MS instructions includes deleting the corresponding mapping from the record that holds the renaming and mapping between the physical and logical names of these scratchpads.

When the type of the exception event is the UBE event triggered by the branch-type MS instruction in the aforementioned branch prediction processing, in addition to the above exception processing, the unlikely branch target indicated by the branch indication information attached to the MS instruction needs to be determined as the next MS instruction after the exception is eliminated. Therefore, after the exception processing is completed, the instruction pipeline may normally jump to the correct branch direction to continue execution.

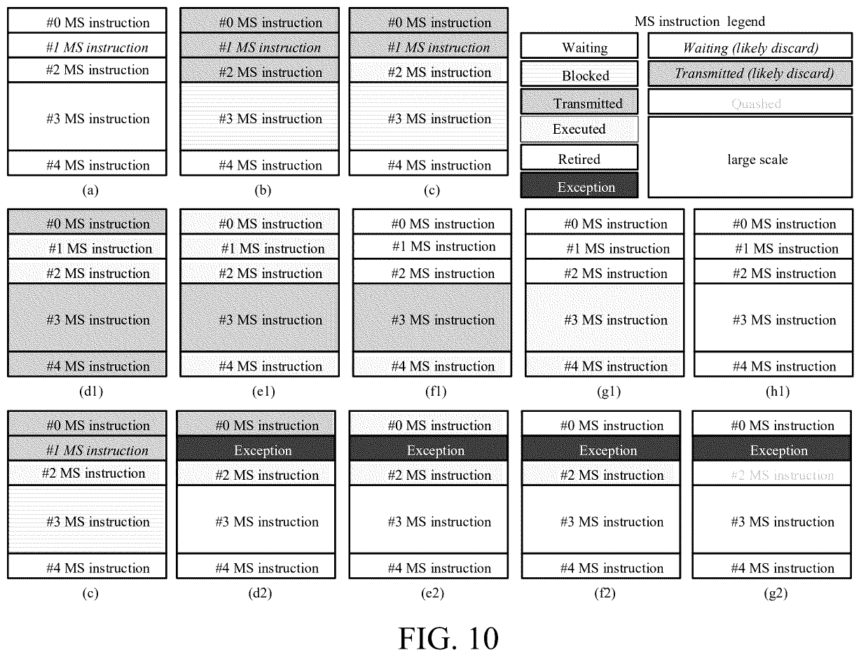

FIG. 10 illustrates an instruction execution example according to an embodiment of the present disclosure.

As shown in the figure, (a) shows initial states of MS instruction streams in an instruction queue, including five MS instructions to be executed, where #1 MS instruction has a likely discard label, and different widths occupied by instructions may represent different scales, #3 MS instruction is a large-scale MS instruction, and the rest are small-scale MS instructions. Different backgrounds of instructions represent different states, such as waiting, blocking, transmitting, executing, retiring, exception, quashing, etc. For specific representations, see the legend.

(b) shows instruction transmission steps, with small-scale instructions being transmitted as soon as possible, while large-scale instructions being blocked by any previous likely discard instruction transmitted. Specifically, #0 instruction is transmitted first, followed by #1 instruction. When #1 instruction is transmitted, it is found that the instruction may be discarded. In this case, the subsequent large-scale instruction is blocked. In this example, #2 instruction may still be transmitted normally because it is a small-scale instruction; and #3 instruction is blocked because it is a large-scale instruction, and subsequent instructions are also in a waiting state.

(c) shows an instruction execution process. In this example, #2 instruction may have been completed first, and because the instructions before it have not been completed, it needs to wait to ensure sequential submission.

(d1)-(h1) show the processing procedures when no exceptions occur during the execution of the aforementioned instructions; (d2)-(g2) show the processing procedures when the aforementioned instruction throws an exception.

Specifically, (d1) shows that #1 instruction has also been completed normally and is not discarded. At this point, large-scale instruction #3 that is blocked because of #1 instruction may be transmitted, and the subsequent #4 instruction may also be transmitted normally. (e1) shows that #0, #1, #2, and #4 instructions have all been completed due to their small scale, while the #3 instruction is still being executed. (f1) shows that #0, #1, and #2 instructions are submitted sequentially, while #4 instruction must wait for #3 instruction to be completed before submission. (g1) shows that #3 instruction has also been completed. (h1) shows that #3 and #4 instructions are submitted sequentially.

On the other hand, when an exception occurs during the execution of #1 instruction, as shown in (d2), an exception program will be processed at this time. The process of exception processing usually includes exception processing preparation, determining the source of the exception, saving the execution state, processing the exception, restoring the execution state and returning. For example, in the exception processing circuit 516 shown in FIG. 5, whether an exception occurs may be recorded, and the address of the next MS instruction may be adjusted according to the processing result.

Precise exception processing is performed when the exception is processed. As shown in (e2) and (f2), #0 instruction that precedes #1 instruction that triggers the exception continues to execute and complete the submission. Although #2 instruction that is transmitted after #1 instruction that triggers the exception has already been completed, it is also to be quashed, as shown in (g2). At this point, #3 instruction and #4 instruction, which have not been transmitted due to being blocked, are in a waiting state, thereby avoiding the overhead caused by quashing.

If the exception triggered by #1 instruction is the UBE event described earlier, in other words, #1 instruction is a branch instruction, according to the branch indication information attached to the branch instruction, the unlikely branch target indicated by it may be determined as the next MS instruction after the exception is eliminated. In other words, after the exception processing is completed, the pipeline will jump to the MS instruction corresponding to the unlikely branch target.

If the exception is of another type, for example, the denominator in division being zero, the pipeline will jump to an exception processing program. This program may modify the denominator value to a very small non-zero value. After the exception processing is completed, #1 instruction will be re-executed and the normal instruction pipeline processing will continue.

In contrast to exception events, interrupt events come from outside the SoC and are therefore unpredictable. However, SaaP does not need to precisely stop at this point where the interrupt signal is triggered. When an interrupt occurs, SaaP blocks all MS instructions waiting to be transmitted and waits for all transmitted MS instructions to complete and retire.

In SaaP, most system management exceptions, such as bad allocation, page fault, segment fault, etc., may only be raised from the mother core and therefore are also captured and processed within the mother core. Other components in the SaaP architecture and other IP cores are neither affected by these exceptions nor aware of them.

### Vesicle

In SaaP, for mixed-scale data access, vesicles are used as an alternative form of registers. Vesicles may be some independent, mixed-size single-port scratchpads, with capacity sizes ranging from 64 B to 512 KB, for example. In SaaP, vesicles may be similar to registers with mixed capacity for use by MS instructions. The “vesicle complex” herein refers to a physical “register” file composed of vesicles, rather than a register of a fixed size. Preferably, the number of small-capacity (such as 64 B) vesicles is greater than that of large-capacity (such as 512 KB) vesicles, which facilitates better matching of program requirements and support for tasks of different scales. Physically, each vesicle may be a single SRAM or register, which has two read ports and one write port. These vesicles are designed to better match the mixed-scale data access pattern, and they may be used as the basic units of data management in SaaP.

Two IP cores may not access the same vesicle at the same time. Therefore, data dependencies may still be managed as simply as sequential scalar processors, and on-chip IP collaboration may be managed via a hardware MS instruction pipeline.

### Data Path

In order to access any vesicle from any IP core, a complete connection between the IP core complex and the vesicle complex is required. Common solutions include data buses (such as those in CPUs) or cross matrices (such as those in multi-core systems). However, none of these connections may meet the need for efficiency. For example, the data bus may lead to competition, and the cross matrix takes up a lot of space, even if there are only a few dozen cores. To achieve non-blocking data transmission at an acceptable cost, the embodiment of the present disclosure discloses an on-chip interconnection data path based on a sorting network implementation, known as Golgi.

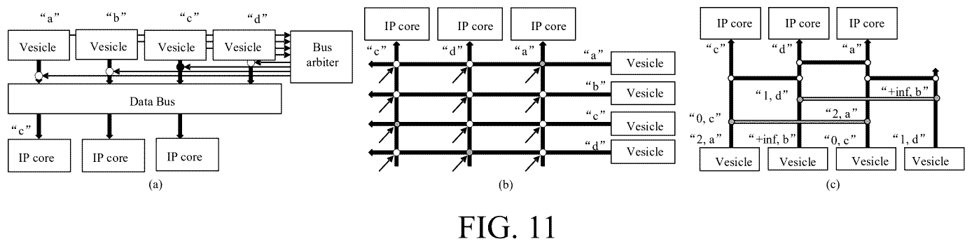

FIG. 11 illustrates several different data path designs, where (a) shows a data bus, (b) shows a cross matrix, and (c) shows a Golgi provided in the embodiment of the present disclosure.

As can be seen from (a), the data bus may not provide non-blocking access and requires a bus arbiter to resolve access conflicts. As can be seen from (b), the cross matrix may provide non-blocking access and has low latency, but it requires O(mn) switches, where m is the number of ports of the IP core, and n is the number of ports of the vesicle.

In the Golgi shown in the (c), the connection problem is treated as a Top-K sorting network, where vesicle ports are sorted based on destination IP port numbers. On-chip interconnection includes a bitonic sorting network composed of a plurality of comparators and a plurality of switches. When m IP core ports need to access n vesicle ports, the data path between the m IP core ports and the n vesicle ports is constructed by sorting related vesicle ports using the bitonic sorting network based on indexes of destination IP core ports.

For the example in (c), when it is necessary to map vesicles {a,c,d} to IP cores {#3, #1, #2} respectively, Golgi treats the mapping as a sorting of all vesicles {a,b,c,d}, which respectively have values {#3, #+∞, #1, #2}, where the unused ports are assigned destination numbers +∞.

Specifically, as shown in (c), starting from the vesicles {a,b,c,d}, even columns are compared with each other first and then odd columns are compared with each other. For example, vesicles a and c are compared, and if it is found that the value #3 of the vesicle a is greater than the value #1 of the vesicle c, then the two are swapped. The light shaded line in the figure indicates that the switch is on and the data may flow laterally. Vesicles b and d are compared, and if it is found that the value #too of the vesicle b is greater than the value #2 of the vesicle d, the two are also swapped, the switch is on, and the data path flows laterally. At this time, the sorting positions are c, d, a, and b. Next, two adjacent vesicles are compared. For example, vesicles c and d are compared, and if it is found that the value #1 of the vesicle c is less than the value #2 of the vesicle d, the two remain unchanged, the switch is not on, and the data path may only flow vertically. Similarly, after vesicles d and a are compared, the switch is not on; and after vesicles a and b are compared, the switch is not on.

Finally, it may be seen that each IP core exactly corresponds to the vesicle it is going to access. For example, for IP #1, a data path to its vesicle is to go straight down from the path beneath it to the grey dot, then move horizontally, and then go straight down to the vesicle c. The data paths of other IP cores are similar. Thus, a non-blocking data path is constructed between the IP core and the vesicle based on the sorting network.

Using the bitonic sorting network, Golgi may be implemented with O(n(log k)²) comparators and switches, and this number is much smaller than O(nk) switches required by the cross matrix. Data delivered through Golgi will undergo several cycles of delay (for example, 8 cycles), so the preferred practice is to place as little local cache as possible in the IP core (1 KB is sufficient), because it relies on a large number of random accesses.

In summary, in order to execute an MS instruction, SaaP establishes an exclusive data path between the IP core and its vesicle. This exclusive data path in SaaP follows a PXO architecture and provides non-blocking data access at minimal hardware cost.

By passing vesicles between MS instructions, data may be shared between IP cores. Since the mother core manages the system memory, the input data is collected together in one MS instruction through the mother core and correctly placed in one vesicle for use by another MS instruction. After being processed by the IP core, the output data is similarly distributed back to the system memory by the mother core. Specifically, the complete data path from the system memory to the IP core includes: [(loading MS instruction) \textcircled{1} memory \textcircled{2} L3/L2 cache \textcircled{3} mother core \textcircled{4} Golgi W0 \textcircled{5} vesicle, (consuming MS instruction) \textcircled{5} same vesicle \textcircled{6} Golgi R0/1 \textcircled{7} IP core.]

From a logical perspective, the system memory is exclusively owned by the mother core, which greatly reduces system complexity in the following aspects:
1) page errors are only initiated by the mother core and processed within it, so other MS instructions are always safely executed under the condition of ensuring no page errors;
2) L2/L3 cache is exclusively owned by the mother core, so cache inconsistency/contention/pseudo-sharing never occurs; and
3) interrupts are always processed by the mother core, so other IP cores (literally) are not interrupted.

### Programming

SaaP may adapt to various general-purpose programming languages (such as C, C++, Python, etc.) as well as domain-specific languages. Since any task executed on SaaP is an MS instruction, the key technique is to extract mixed-scale operations to form MS instructions.

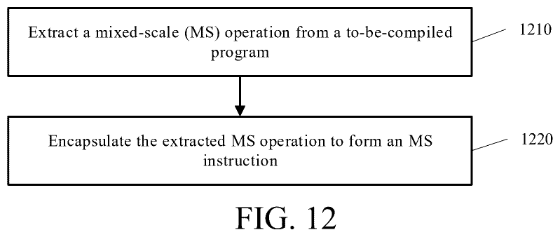

FIG. 12 illustrates an exemplary flowchart of a compilation method according to an embodiment of the present disclosure.

As shown in the figure, in step 1210, an MS operation is extracted from a to-be-compiled program, where these MS operations have a variable CPI. Next, in step 1220, the extracted MS operation is encapsulated to form an MS instruction.

The low-level operations may be extracted from basic instruction blocks, while the high-level operations may be extracted by various means, including but not limited to: 1) directly calling and mapping from a library; 2) reconstructing from a low-level program structure; and 3) manually setting compiler directives. Therefore, existing programs, such as deep learning applications written in Python using PyTorch, may be compiled to the SaaP architecture in a manner similar to the multi-scalar channel.

In some embodiments, the following five LLVM compilation passes may optionally be added to extend the traditional compiler.

a) Call-Map (call-map pass): a compilation pass driven by a simple work list, which converts known library calls into MS instructions. The specific implementation of the MS instruction is precompiled from vendor-specific code and is referenced as a library during this process.

Specifically, in an implementation, a call to a library function may be extracted from a to-be-compiled program as an MS operation; and then, according to a mapping list of the library function to the MS template library, the extracted call to the library function is converted to a corresponding MS instruction. The MS template library is precompiled based on code specific to the execution unit that may execute the library function.

b) Reconstruct (reconstruction pass): another compilation pass driven by a simple work list, which attempts to restore a high-level structure from low-level code, thus discovering a high-level MS instruction.

Specifically, in an implementation, a specified program structure in the to-be-compiled program is identified through template matching as an MS operation; and the identified specified program structure is converted into a predetermined MS instruction. The template may be predefined based on the characteristics of the advanced functional structure. For example, the template may define a nested loop structure and set some parameters for the nested loop structure, such as how many nested loops there are, the size of each loop, what operations are there in the innermost loop, etc. The template may be defined according to some typical advanced structures, such as a convolution operation structures, fast fourier transform (FFT), etc. The specific definition content and definition method are not limited in the embodiment of the present disclosure.

For example, the FFT implemented by the user (as a nested loop) may be captured through template matching, and then it may be replaced by using the FFT MS instructions of the vendor-specific library used in the Call-Map. The restored FFT MS instructions may be executed more effectively on the DSP IP core (if available), and in the worst case where only the CPU is available, they may also be converted back to the nested loop. This is done with the greatest effort because, essentially, it is very difficult to precisely reconstruct all the advanced structures, but this provides an opportunity for old programs that do not know DSA to take advantage of the new DSP IP core.

c) Control data flow graph (CDFG)—analysis pass: unlike the multi-scalar technique, a program conducts analysis on the CDFG instead of on a control flow graph (CFG). This is because SaaP removes register masks and address resolution mechanisms and organizes data into vesicles. After the previous two compilation passes, operators to be performed on heterogeneous IP cores may be identified. All the remaining code should be executed on the CPU as multi-scalar tasks. At this point, the problem is to find the optimal division that divides the remaining code into MS instructions. A global CDFG is constructed for subsequent modeling of the cost of dividing different MS instructions.

Specifically, in an implementation, on the CFG of the to-be-compiled program, operations that have not been extracted in the to-be-compiled program may be divided into one or a plurality of operation sets according to various division solutions; and then a division solution with the optimal division cost is determined. In each division solution, each operation belongs to and only belongs to one operation set.

There are various division methods. Basically, the division solution may be implemented by following one or more of the following constraints.

For example, the arities of the input and output data of an operation set do not exceed a specified value. As specified by the MS instruction, the arity of the input data does not exceed 2, and the arity of the output data does not exceed 1. Therefore, operation division may be carried out based on this constraint.

For example, the size of any input or output data of an operation set does not exceed a specified threshold. Since the storage element corresponding to the MS instruction is a vesicle, which has a capacity limit, it is necessary to limit the amount of data processed by the MS instruction to no more than the capacity limit of the vesicle.

For example, during division, the division solution related to conditional operations may include followings.
1. The conditional operation and its two branch operations are preferentially divided into a same operation set. At this time, the MS instruction corresponding to the operation set is a common computing instruction.
2. The conditional operation and its two branch operations are not in the same operation set. Possible reasons for this division solution are as follows: it results in a large operation set; or it violates input/output constraints; or the branch operations have been identified as MS instructions in the previous step. In this case, a branch-type MS instruction containing a conditional operation will be generated. Generally speaking, placing conditional operations in a short set of operations may yield branch results more quickly during execution. For example, it is possible to control that the same operation set does not simultaneously contain conditional operations and unconditional operations that exceed the execution duration threshold.

The division cost of the division solution may be determined based on a variety of factors, including, but not limited to, the number of operation sets; the amount of data interaction required between operation sets; the number of operation sets that undertake branch functions; and the distribution uniformity of the expected execution durations of each of the operation sets. These factors affect the execution efficiency of the instruction pipeline from many aspects, so they may be used as a measure to determine the division solution. For example, the number of operation sets directly corresponds to the number of MS instructions; the amount of data interaction required between operation sets determines the amount of data I/O required; the more branch-type instructions there are, the greater the probability that an exception may be triggered is, and the greater the consumption of the pipeline is; and the distribution uniformity of the expected execution durations affects the overall operation of the pipeline and avoids the interrupt of the pipeline caused by excessive time consumption at a certain level.

In some embodiments, the above CDFG analysis pass is performed after the Call-Map and the Reconstruct. Therefore, it is possible to execute the above CDFG analysis pass only for MS operations that are not recognized in the first two compilation passes; in other words, it is possible to execute the above CDFG analysis pass for the remaining operations.

d) MS-Cluster (MS-cluster transformation pass): a transformation compilation pass used to cluster nodes in the CDFG to construct a complete division to the MS instructions.

Specifically, in an implementation, according to the division solution determined during the CDFG analysis pass, each operation set is converted into one MS instruction separately. Limited by the capacity of the vesicle, the algorithm minimizes the total cost of the cutting edge across the MS instruction boundary. Specially, MS instructions including load/store operations and system calls are designated to the mother core.

e) Fractal-Decompose (fractal-decomposition pass): a transformation compilation pass used to decompose the MS instructions that violate the vesicle capacity limit extracted from the Call-Map and the Reconstruct, so that the vesicle capacity no longer limits the function of SaaP.

Specifically, in an implementation, the decomposition pass includes: checking whether the converted MS instruction complies with the storage capacity constraint of the MS instruction; and dividing the MS instruction into a plurality of MS instructions to achieve the same function when the MS instruction does not comply with the storage capacity constraint.

Various existing known or future developed instruction decomposition methods may be adopted to decompose the MS instruction. Since the previously extracted MS instruction is to be assigned to a certain IP core for execution, a plurality of operations that constitute this MS instruction are of the same type, in other words, isomorphic, but need to be adapted to the physical hardware size. Thus, in some embodiments, the decomposition pass of this MS instruction may simply follow the fractal execution model. For example, reference may be made to Y. Zhao, Z. Du, Q. Guo, S. Liu, L. Li, Z. Xu, T. Chen, and Y. Chen et al., “Cambricon-F: Machine Learning Computers with Fractal von Neumann Architecture,” in Proceedings of the 46th International Symposium on Computer Architecture, 2019, pp. 787-800. Generally speaking, the MS instruction may be decomposed into several smaller and similar operations through an iterative approach. Since the invention of the embodiment of the present disclosure does not lie in the specific way of instruction decomposition, it will not be elaborated here.

Encapsulating the MS operation into the MS instruction, simply put, is to fill one or a plurality of instruction domains of the MS instruction. As mentioned earlier, the MS instruction includes a sub-instruction domain, an input and output vesicle information domain, and may also include a system memory address information domain, a branch information domain, and an exception marker domain. Some of these instruction domains are mandatory, such as the sub-instruction domain, the exception marker domain, etc. Some are filled on demand, such as the input and output vesicle information domain, the system memory address information domain, the branch information domain, etc.

When filling the sub-instruction domain, the MS operation may be identified in the sub-instruction domain of the MS instruction; and the sub-instruction domain is associated with sub-instructions specific to one or a plurality of execution units and used to implement this MS operation.

In some embodiments, for a conditional computation MS instruction associated with a branch MS instruction, a likely discard label may be inserted in the exception marker domain for subsequent execution of MS instructions.

In some embodiments, for a branch-type MS instruction, a branch indicator may be inserted in the branch information domain to indicate a likely branch target and/or an unlikely branch target.

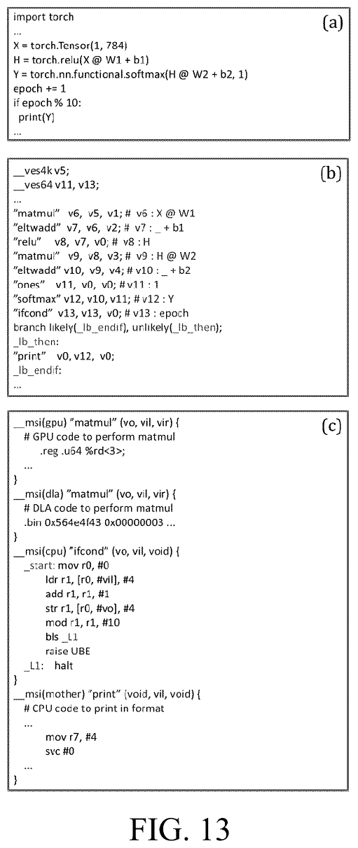

FIG. 13 shows an exemplary program, where (a) shows an original to-be-compiled program; the compiled program is divided into two parts, where (b) shows the compiled MS instruction stream, and (c) shows the IP-specific MS instruction implementation, which is the sub-instruction described earlier.

In this example, the original program involves computations of the Relu layer and Softmax layer of neural networks in deep learning applications, for example, written in Python language using PyTorch. The computations of the Relu layer and Softmax layer adopt the method of calling the Torch library. Thus, according to the Call-Map pass described earlier, these function calls to the Torch library may be mapped to MS instructions, such as “Matmul (matrix multiplication)”, “Eltwadd (element-wise addition)”, “Relu”, and so on, as shown in (b). The increment of the variable Epoch and the conditional branch are packaged and mapped to a conditional branch instruction “Ifcond”, and a branch indicator is inserted at the same time to indicate likely branch targets and unlikely branch targets. Print statement is mapped to another MS instruction (“Print”).

(c) shows several MS instructions with IP-specific codes. As shown, Matmul provides two IP-specific code implementations, one for GPU and the other for DLA, so that the “Matmul” MS instruction may be scheduled between the GPU lane and the DLA lane by the instruction dispatcher. Ifcond only provides CPU-specific code, which involves reading the Epoch from the first input vesicle (vil), increasing it by 1, and then storing it in the output vesicle (vo). The result 10 of the new Epoch value modulo 10 is computed, and the judgment is made based on this result accordingly. If it is determined that a “Then” branch (which is compared to an unlikely branch) is to be adopted, a “UBE” event is initiated. Therefore, the Ifcond MS instruction also inserts a “likely discard label”, and any subsequent large-scale MS instructions will be blocked until the Ifcond instruction has been executed. The Print MS instruction is only dispatched to the mother core because this instruction requires system calls and I/O with external devices.

Thus, the above describes an exemplary solution for compiling program code into MS instructions. The to-be-compiled program code may be various general-purpose programming languages or domain-specific languages. By compiling these program codes into MS instructions, various new IP cores may be added to the SaaP SoC very conveniently without the need for a large amount of programming/compilation work. Therefore, it may well support the scalability of the SoC. Furthermore, the same MS instruction may use a plurality of versions of sub-instructions, which also provides more options for the scheduling during instruction execution and facilitates the improvement of the execution efficiency of the pipeline.

In summary, SaaP provides an outstanding design option for the traditional perception of heterogeneous SoCs. In SaaP, since there are no shared resources under the PXO principle, there is no competition. MS instructions may be predicted and executed and quashed when errors occur without any overhead, because there is nothing in the IP core during execution that leaves observable side effects due to incorrect instructions. The cache does not need to be consistent because there are no duplicate cache lines, and the snoop filter/MESI protocol is saved because there is no bus to be snooped. Although additional constraints have been imposed on SaaP, it may be seen from the description in this article that these constraints are reasonable from both analytical and empirical perspectives.

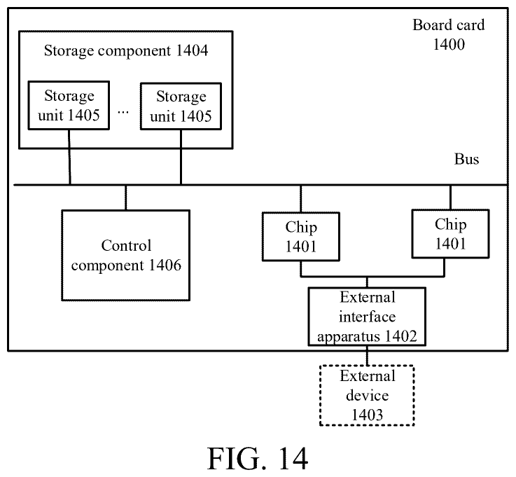

FIG. 14 is a schematic diagram of a structure of a board card 1400 according to an embodiment of the present disclosure. As shown in the figure, the board card 1400 includes a chip 1401, which may be an SaaP SoC of the embodiment of the present disclosure, integrated with one or a plurality of combined processing apparatuses. The combined processing apparatus is an artificial intelligence computing unit configured to support various deep learning and machine learning algorithms and meet the intelligent processing requirements in complex scenarios in computer vision, speech, natural language processing, data mining, and other fields. In particular, deep learning technology is widely used in the cloud intelligence field. A notable feature of cloud intelligence applications is the large amount of input data, which has high requirements for storage capacity and computing power of a platform. The board card 1400 of this embodiment is suitable for cloud intelligent applications and has huge off-chip storage, huge on-chip storage, and great computing power.

The chip 1401 is connected to an external device 1403 through an external interface apparatus 1402. The external device 1403 may be, for example, a server, a computer, a camera, a monitor, a mouse, a keyboard, a network card, or a WIFI interface. To-be-processed data may be transferred from the external device 1403 to the chip 1401 through the external interface apparatus 1402. A computing result of the chip 1401 may be transferred back to the external device 1403 through the external interface apparatus 1402. Depending on application scenarios, the external interface apparatus 1402 may have different interface forms, such as a peripheral component interconnect express (PCIe) interface.

The board card 1400 further includes a storage component 1404 configured to store data. The storage component 1404 includes one or a plurality of storage units 1405. The storage component 1404 is connected to and transfers data to a control component 1406 and the chip 1401 through a bus. The control component 1406 in the board card 1400 is configured to regulate and control a state of the chip 1401. As such, in an application scenario, the control component 1406 may include a micro controller unit (MCU).

The SoC chip in the board card provided by this disclosed embodiment may contain corresponding features described above and will not be repeated here. The embodiment of the present disclosure also provides a corresponding compilation apparatus, including a processor, configured to execute compilation program code; and a memory, configured to store the compilation program code, where when the compilation program code is loaded and executed by the processor, the compilation apparatus performs the compilation method described in any of the preceding embodiments. The embodiment of the present disclosure also provides a machine-readable storage medium that includes compilation program code that, when executed, enables the machine to perform the compilation method described in any of the preceding embodiments.

According to different application scenarios, a device or apparatus of the present disclosure may include a server, a cloud server, a server cluster, a data processing apparatus, a robot, a computer, a printer, a scanner, a tablet, a smart terminal, a PC device, an Internet of Things terminal, a mobile terminal, a mobile phone, a traffic recorder, a navigator, a sensor, a webcam, a camera, a video camera, a projector, a watch, a headphone, a mobile storage, a wearable device, a visual terminal, an autonomous driving terminal, a vehicle, a household appliance, and/or a medical device. The vehicle includes an airplane, a ship, and/or a car; the household appliance includes a television, an air conditioner, a microwave oven, a refrigerator, an electric rice cooker, a humidifier, a washing machine, an electric lamp, a gas cooker, and a range hood; and the medical device includes a nuclear magnetic resonance spectrometer, a B-ultrasonic scanner, and/or an electrocardiograma electronic device or apparatus of the present disclosure may be further applied to Internet, Internet of Things, data center, energy, transportation, public management, manufacturing, education, power grid, telecommunications, finance, retail, construction sites, medical, and other fields. Further, the electronic device or apparatus of the present disclosure may be further used in application scenarios including cloud, edge, and terminal related to artificial intelligence, big data, and/or cloud computing. In one or a plurality of embodiments, according to the solution of the present disclosure, an electronic device or apparatus with high computing power may be applied to a cloud device (such as the cloud server), while an electronic device or apparatus with low power consumption may be applied to a terminal device and/or an edge device (such as a smart phone or the webcam). In one or a plurality of embodiments, hardware information of the cloud device is compatible with that of the terminal device and/or the edge device. As such, according to hardware information of the terminal device and/or the edge device, appropriate hardware resources may be matched from hardware resources of the cloud device to simulate hardware resources of the terminal device and/or the edge device, so as to complete unified management, scheduling, and collaborative work of terminal-cloud integration or cloud-edge-terminal integration.

It is required to be explained that, for the sake of brevity, the present disclosure describes some method embodiments as a series of actions and combinations thereof, but those skilled in the art may understand that the solution of the present disclosure is not limited by an order of actions described. Therefore, according to the present disclosure or under the teaching of the present disclosure, those skilled in the art may understand that some steps of the method embodiments may be performed in a different order or simultaneously. Further, those skilled in the art may understand that the embodiments described in the present disclosure may be regarded as optional embodiments; in other words, actions and units involved thereof are not necessarily required for the implementation of a certain solution or some solutions of the present disclosure. Additionally, according to different solutions, descriptions of some embodiments of the present disclosure have their own emphases. In view of this, those skilled in the art may understand that, for a part that is not described in detail in a certain embodiment of the present disclosure, reference may be made to related descriptions in other embodiments.

In terms of specific implementations, according to the present disclosure and under the teaching of the present disclosure, those skilled in the art may understand that several embodiments disclosed in the present disclosure may be implemented in other ways that are not disclosed in the present disclosure. For example, for units in the aforementioned electronic device or apparatus embodiment, the present disclosure divides the units on the basis of considering logical functions, but there may be other division methods during actual implementations. For another example, a plurality of units or components may be combined or integrated into another system, or some features or functions in the units or components may be selectively disabled. In terms of a connection between different units or components, the connection discussed above in combination with drawings may be direct or indirect coupling between the units or components. In some scenarios, the direct or indirect coupling relates to a communication connection using an interface, where the communication interface may support electrical, optical, acoustic, magnetic, or other forms of signal transmission.

In the present disclosure, units described as separate components may be or may not be physically separated. Components shown as units may be or may not be physical units. The components or units may be located in a same position or distributed to a plurality of network units. Additionally, according to actual requirements, some or all of the units may be selected for achieving the purpose of the solution described in the embodiments of the present disclosure. Additionally, in some scenarios, the plurality of units in the embodiments of the present disclosure may be integrated into one unit, or each of the units may be physically separated.

In some other implementation scenarios, the integrated unit may be implemented in the form of hardware. The hardware may be a specific hardware circuit, which may include a digital circuit and/or an analog circuit, and the like. A physical implementation of a hardware structure of the circuit includes but is not limited to a physical component. The physical component includes but is not limited to a transistor, or a memristor, and the like. In view of this, various apparatuses (such as the computing apparatus or other processing apparatus) described in the present disclosure may be implemented by an appropriate hardware processor, such as a CPU, a GPU, an FPGA, a DSP, and an ASIC, and the like. Further, the aforesaid storage unit or storage apparatus may be any appropriate storage medium (including a magnetic storage medium or a magneto-optical storage medium, and the like), such as a resistive random access memory (RRAM), a DRAM, a static random access memory (SRAM), an enhanced dynamic random access memory (EDRAM), a high bandwidth memory (HBM), a hybrid memory cube (HMC), an ROM, and an RAM, and the like.

The foregoing may be better understood according to following articles.
Article A1. A system on chip (SoC), including:
a system controller configured to manage a hardware pipeline, including fetching an instruction from a system memory, decoding and dispatching the instruction; and
a plurality of heterogeneous IP cores constituting execution units in the hardware pipeline for executing the instruction dispatched by the system controller.
Article A2. The SoC of article A1, further including:
a set of vesicles including a plurality of scratchpads with unequal storage capacities for caching data related to executions of the plurality of heterogeneous IP cores.
Article A3. The SoC of article A2, where the capacities of the vesicles range from 64 B to 512 KB, and the number of small-capacity vesicles is greater than that of large-capacity vesicles.
Article A4. The SoC of article A2 or A3, where among the plurality of heterogeneous IP cores, there is a mother core, which exclusively manages data exchange between the system memory and the vesicles.
Article A5. The SoC of article A4, where the mother core is further configured to host an operating system and runtime and is responsible for at least one or more of the following: process management, page management, exception processing, and interrupt processing.
Article A6. The SoC of article A5, where the mother core is further configured to:
implement branch and prediction executions through exception processing, where an unlikely branch is treated as an unlikely branch exception (UBE) for processing.
Article A7. The SoC of article A6, where the branch and prediction executions are implemented by using static prediction.
Article A8. The SoC of any one of articles A4-A7, further including:
on-chip interconnection configured to provide a non-blocking data path connection between the plurality of heterogeneous IP cores and the set of vesicles, where the on-chip interconnection is implemented based on a sorting network.
Article A9. The SoC of article A8, where the on-chip interconnection includes a bitonic sorting network composed of a plurality of comparators and a plurality of switches, and when m IP core ports need to access n vesicle ports, a data path between the m IP core ports and the n vesicle ports is constructed by sorting related vesicle ports using the bitonic sorting network based on indexes of destination IP core ports.
Article A10. The SoC of article A9, where the on-chip interconnection includes three bitonic sorting networks, with two for read ports and one for write ports. Article A11. The SoC of any one of articles A4-A10, where
the instruction includes a mixed-scale (MS) instruction, where the MS instruction includes a sub-instruction domain, which indicates sub-instruction information specific to one or a plurality of IP cores capable of executing the MS instruction; and the system controller is further configured to: dispatch the MS instruction to a corresponding IP core according to the sub-instruction domain.
Article A12. The SoC of article A11, where
each MS instruction has at most two input data domains and one output data domain, which are used to indicate data information related to the execution of the MS instruction.
Article A13. The SoC of article A12, where
a data domain of an MS instruction executed on an IP core other than the mother core points to a corresponding vesicle in the set of vesicles, and a vesicle corresponding to output data is exclusively dispatched to an IP core executing the MS instruction.
Article A14. The SoC of any one of articles A11-A13, where
the plurality of heterogeneous IP cores other than the mother core are divided into different IP lanes according to their functions; and
the system controller is further configured to: dispatch the MS instruction to an appropriate IP lane at least partly based on the task type of the MS instruction.
Article A15. The SoC of any one of articles A2-A14, where the system controller is further configured to use a renaming mechanism for the vesicles to achieve one or more of the following processing:
resolving a data hazard on the vesicles;
quashing the MS instruction; and
submitting the MS instruction.
Article A16. A board card, including the SoC of any one of articles A1-A15.
Article B1. An instruction processing apparatus, including:
an instruction decoder configured to decode a mixed-scale (MS) instruction, where the MS instruction includes a sub-instruction domain, which indicates sub-instruction information specific to one or a plurality of execution units capable of executing the MS instruction; and
an instruction dispatcher configured to dispatch the MS instruction to a corresponding execution unit according to the sub-instruction domain.
Article B2. The apparatus of article B1, where the plurality of execution units are divided into different lanes according to their functions, and
the instruction dispatcher is further configured to: dispatch the MS instruction to a reservation station corresponding to an appropriate lane for subsequent transmission to an appropriate execution unit at least partly based on the task type of the MS instruction.
Article B3. The apparatus of article B4, where the instruction dispatcher is further configured to: schedule among the lanes to which the plurality of execution units capable of executing the MS instruction belong based on processing states in the lanes.
Article B4. The apparatus of any one of articles B1-B3, where the instruction dispatcher is further configured to:
dispatch the MS instruction of the specified type to a master execution unit responsible for management in the execution units.
Article B5. The apparatus of article B4, where the MS instruction of the specified type includes any of the following:
an MS instruction for accessing a system memory;
an MS instructions for processing an interrupt;
an MS instructions that is unable to be processed by other execution units; and
an MS instruction dispatched to the master execution unit according to an MS instruction scheduling policy.
Article B6. The apparatus of article B4 or B5, where sub-instruction specific to the one or the plurality of execution units is pre-fetched and stored on a sub-instruction cache, so that the execution unit fetches the corresponding sub-instruction from the sub-instruction cache when the MS instruction is transmitted to the corresponding execution unit.
Article B7. The apparatus of any one of articles B1-B6, where
an operation-type MS instruction performs operations on data stored in a set of vesicles, where the set of vesicles is composed of a plurality of scratchpads with unequal storage capacities.
Article B8. The apparatus of article B7, further including:
a vesicle renaming circuit configured to, when there is a data hazard on a vesicle involved in the MS instruction, rename and map a logical name of the vesicle to a physical name, and save the mapping between the physical name and the logical name before the MS instruction is dispatched.
Article B9. The apparatus of article B8, further including:
an instruction retire circuit configured to retire the completed MS instruction sequentially, and when the MS instruction retires, submit an execution result by confirming the renaming and mapping of a vesicle corresponding to output data of the MS instruction.
Article B10. The apparatus of any one of articles B1-B9, where each MS instruction has at most two input data domains and one output data domain.
Article B11. The apparatus of any one of articles B1-B10, where the execution unit includes a plurality of heterogeneous IP cores integrated on a system on chip (SoC).
Article B12. An instruction execution method, including:
decoding a mixed-scale (MS) instruction, where the MS instruction includes a sub-instruction domain, which indicates sub-instruction information specific to one or a plurality of execution units capable of executing the MS instruction; and
dispatching the MS instruction to a corresponding execution unit according to the sub-instruction domain.
Article B13. The method of article B12, where the plurality of execution units are divided into different lanes according to their functions, and dispatching the MS instruction to the corresponding execution unit further includes:
dispatch the MS instruction to a reservation station corresponding to an appropriate lane for subsequent transmission to an appropriate execution unit at least partly based on the task type of the MS instruction.
Article B14. The method of article B13, where dispatching the MS instruction to the corresponding execution unit further includes:
scheduling among the lanes to which the plurality of execution units capable of executing the MS instruction belong based on processing states in the lanes.
Article B15. The method of any one of articles B12-B14, where dispatching the MS instruction to the corresponding execution unit further includes:
dispatching the MS instruction of the specified type to a master execution unit responsible for management in the execution units.
Article B16. The method of article B15, where the MS instruction of the specified type includes any of the following:
an MS instruction for accessing a system memory;
an MS instructions for processing an interrupt;
an MS instructions that is unable to be processed by other execution units; and
an MS instruction dispatched to the master execution unit according to an MS instruction scheduling policy.
Article B17. The method of article B15 or B16, further including:
pre-fetching and storing sub-instruction specific to the one or the plurality of execution units on a sub-instruction cache; and
fetching, by the execution unit, the corresponding sub-instruction from the sub-instruction cache when the MS instruction is transmitted to the corresponding execution unit.
Article B18. The method of any one of articles B12-B17, where
an operation-type MS instruction performs operations on data stored in a set of vesicles, where the set of vesicles is composed of a plurality of scratchpads with unequal storage capacities.
Article B19. The method of article B18, further including:
in the conflict resolution stage before dispatching the MS instruction, when there is a data hazard on a vesicle involved in the MS instruction, renaming and mapping a logical name of the vesicle to a physical name; and
saving the mapping between the physical name and the logical name.
Article B20. The method of article B19, further including:
when the MS instruction retires, submitting an execution result by confirming the renaming and mapping of a vesicle corresponding to output data of the MS instruction.
Article B21. The method of article B20, where the decoding, conflict resolution, dispatching, executing and retiring of the MS instruction are executed in parallel according to an out-of-order pipeline.
Article B22. The method of any one of articles B12-B21, where each MS instruction has at most two input data domains and one output data domain.
Article B23. The method of any one of articles B12-B22, where the execution unit includes a plurality of heterogeneous IP cores integrated on a system on chip (SoC).
Article B24. A system on chip (SoC), including the instruction processing apparatus of any one of articles B1-B11, and a plurality of heterogeneous IP cores serving as the execution units.
Article B25. A board card, including the SoC of article B24.
Article C1. An instruction execution method, including:
decoding a mixed-scale (MS) instruction, where the MS instruction has a variable cycle per instruction (CPI); and
obtaining a next MS instruction according to branch indication information in response to the MS instruction being a branch instruction, where the branch indication information indicates a likely branch target and/or an unlikely branch target.
Article C2. The method of article C1, where obtaining the next MS instruction according to the branch indication information includes:
determining the likely branch target indicated by the branch indication information as the next MS instruction.
Article C3. The method of article C2, further including:
receiving an unlikely branch exception (UBE) event, where the UBE event is triggered by an execution unit that executes a conditional computation instruction associated with the branch instruction, and the UBE indicates that a branch direction should be an unlikely branch target based on a conditional computation.
Article C4. The method of article C3, further including:
quashing MS instructions after the branch instruction in response to the UBE event;
submitting MS instructions before the branch instruction; and
determining the unlikely branch target indicated by the branch indication information as the next MS instruction.
Article C5. The method of article C4, where quashing the MS instructions after the branch instruction includes:
quashing the quashed MS instructions in an instruction queue;
terminating an execution unit executing the quashed MS instructions; and
discarding a scratchpad that has been written by the quashed MS instructions.
Article C6. The method of article C5, where discarding the scratchpad that has been written by the quashed MS instructions includes:
deleting the corresponding mapping from a record that holds the renaming and mapping between physical and logical names of the scratchpad.
Article C7. The method of article C6, where
an operation-type MS instruction performs operations on data stored in a set of vesicles, where the set of vesicles is composed of a plurality of scratchpads with unequal storage capacities.
Article C8. The method of any one of articles C1-C7, where the range of the CPI of the MS instruction is approximately from 10 to over 10,000 beats.
Article C9. The method of any one of articles C1-C8, where the branch indication information is determined and inserted into the stream of the MS instruction based on static branch prediction during instruction compilation.
Article C10. A machine-readable storage medium, including code that, when executed, enables a machine to perform the method of any one of articles C1-C9
Article C11. A system controller configured to perform the method of any one of articles C1-C9.
Article C12. A system on chip (SoC), including the system controller of article C11 and a plurality of heterogeneous IP cores serving as execution units of the MS instruction.
Article C13. A board card, including the SoC of article C12.
Article D1. An instruction execution method, including:
checking whether a mixed-scale (MS) instruction may be discarded when the MS instruction is transmitted; and
blocking the transmission of specific MS instructions that follow the MS instruction when it is determined that the MS instruction may be discarded.
Article D2. The method of article D1, where checking whether the MS instruction may be discarded includes:
checking whether the MS instruction has a likely discard label.
Article D3. The method of article D2, where the likely discard label is inserted at compile time according to the type of the MS instruction.
Article D4. The method of article D3, where when the type of the MS instruction is a conditional branch instruction, the MS instruction is inserted into the likely discard label.
Article D5. The method of any one of articles D1-D4, further including: transmitting the blocked specific MS instructions in response to a case where the MS instruction that may be discarded blocking the specific MS instructions has been executed normally.
Article D6. The method of any one of articles D1-D5, further including: quashing the MS instruction and MS instructions after the MS instruction in response to an exception in the execution of the MS instruction;
submitting MS instructions before the MS instruction; and
taking an MS instruction of a corresponding exception processing program as a next MS instruction.
Article D7. The method of article D6, where quashing the MS instruction and the MS instructions after the MS instruction includes:
quashing the quashed MS instructions in an instruction queue;
terminating an execution unit executing the quashed MS instructions; and discarding a scratchpad that has been written by the quashed MS instructions.
Article D8. The method of article D7, where discarding the scratchpad that has been written by the quashed MS instructions includes:
deleting the corresponding mapping from a record that holds the renaming and mapping between physical and logical names of the scratchpad.
Article D9. The method of any one of articles D6-D8, further including:
when the exception is an unlikely branch exception (UBE) triggered by a branch-type MS instruction, determining an unlikely branch target indicated by branch indication information attached to the MS instruction as a next MS instruction after the exception is eliminated.
Article D10. The method of any one of articles D1-D9, where the specific MS instructions are MS instructions that satisfy one or more of the following conditions:
MS instructions whose output data corresponds to a scratchpad whose scale is greater than a set threshold;
MS instructions that perform write operations on the system memory;
MS instructions whose execution duration exceeds a predetermined value; or
MS instructions executed by a specific execution unit.
Article D11. A system controller configured to perform the instruction execution method of any one of articles D1-D10.
Article D12. A machine-readable storage medium, including code that, when executed, enables a machine to perform the method of any one of articles D1-D10.
Article D13. A system on chip (SoC), including the system controller of article D11 and a plurality of heterogeneous IP cores serving as execution units of the MS instruction.
Article D14. A board card, including the SOC of article D13. Article E1. A compilation method, including:
extracting a mixed-scale (MS) operation from a to-be-compiled program, where the MS operation has a variable cycle per instruction (CPI); and
encapsulating the MS operation to form an MS instruction.
Article E2. The method of article E1, where the compilation method includes a call-map pass, including:
extracting a call to a library function from the to-be-compiled program as an MS operation; and
converting the call to the library function to a corresponding MS instruction according to a mapping list of a library function to an MS template library.
Article E3. The method of article E2, where the MS template library is pre-compiled based on code specific to an execution unit that is able to execute the library function.
Article E4. The method of article E2 or E3, where the compilation method includes a reconstruction pass, including:
identifying a specified program structure in the to-be-compiled program by template matching as an MS operation; and
converting the specified program structure into a predetermined MS instruction.
Article E5. The method of article E4, where the template is pre-defined according to advanced functional structure characteristics.
Article E6. The method of any one of articles E4-E5, where the compilation method includes a control data flow graph (CDFG) analysis pass, including:
dividing operations that are not extracted in the to-be-compiled program into one or a plurality of operation sets according to various division solutions on the CDFG of the to-be-compiled program; and
determining a division solution with the optimal division cost.
Article E7. The method of article E6, where each operation belongs to and only belongs to one operation set in each division solution.
Article E8. The method of any one of articles E6-E7, where the division solution is performed under one or more of the following constraints:
a conditional operation and its two branch operations are preferentially placed in the same operation set; the arities of input and output data of an operation set does not exceed a specified value; and
a size of any input or output data of an operation set does not exceed a specified threshold.
Article E9. The method of any one of articles E6-E8, where the division cost is determined based on one or more of the following:
the number of operation sets;
the amount of data interaction required between operation sets;
the number of operation sets undertaking branch functions; and
the distribution uniformity of expected execution durations of operation sets.
Article E10. The method of any one of articles E6-E9, where the CDFG analysis pass is performed after the call-map pass and the reconstruction pass.
Article E11. The method of any one of articles E6-E10, where the compilation method includes a cluster transformation pass, including:
converting each operation set into an MS instruction separately according to the determined division solution.
Article E12. The method of any one of articles E4-E11, where the compilation method includes a decomposition pass, including:
checking whether the converted MS instruction complies with the storage capacity constraint of the MS instruction; and
dividing the MS instruction into a plurality of MS instructions to achieve the same function when the MS instruction does not comply with the storage capacity constraint.
Article E13. The method of any one of articles E1-E12, where encapsulating the MS operation to form the MS instruction includes:
identifying the MS operation in a sub-instruction domain of the MS instruction; and
associating the sub-instruction domain with sub-instructions specific to one one or a plurality of execution units and used to implement this MS operation.
Article E14. The method of article E13, where the execution unit includes a plurality of heterogeneous IP cores integrated on a system on chip (SoC), and the sub-instruction is an IP-specific instruction.
Article E15. The method of any one of articles E1-E14, further including:
for a conditional computation MS instruction associated with a branch MS instruction, inserting a likely discard label for a subsequent execution of an MS instruction.
Article E16. The method of any one of articles E1-E15, further including:
for a branch-type MS instruction, inserting a branch indicator to indicate a likely branch target and/or an unlikely branch target.
Article E17. A compilation apparatus, including:
a processor configured to execute compilation program code; and
a memory configured to store the compilation program code that, when loaded and executed by the processor, enables the apparatus to perform the compilation method of any one of articles E1-E16.
Article E18. A machine-readable storage medium, including compilation program code that, when executed, enables a machine to perform the method of any one of articles E1-E16.

The embodiments of the present disclosure have been described in detail above. The present disclosure explains principles and implementations of the present disclosure with specific examples. Descriptions of the embodiments above are only used to facilitate understanding of the method and core ideas of the present disclosure. Simultaneously, those skilled in the art may change the specific implementations and application scope of the present disclosure based on the ideas of the present disclosure. In summary, the content of this specification should not be construed as a limitation on the present disclosure.

1. A system on chip (SoC), comprising:
a system controller configured to manage a hardware pipeline, comprising fetching an instruction from a system memory, decoding and dispatching the instruction; and
a plurality of heterogeneous IP cores constituting execution units in the hardware pipeline for executing the instruction dispatched by the system controller.

2. The SoC of claim 1, further comprising:
a set of vesicles comprising a plurality of scratchpads with unequal storage capacities for caching data related to executions of the plurality of heterogeneous IP cores.

3. The SoC of claim 2, wherein the capacities of the vesicles range from 64 B to 512 KB, and the number of small-capacity vesicles is greater than that of large-capacity vesicles.

4. The SoC of claim 2, wherein among the plurality of heterogeneous IP cores, there is a mother core, which exclusively manages data exchange between the system memory and the vesicles.

5. The SoC of claim 4, wherein the mother core is further configured to host an operating system and runtime and is responsible for at least one or more of the following: process management, page management, exception processing, and interrupt processing.

6. The SoC of claim 5, wherein the mother core is further configured to:
implement branch and prediction executions through exception processing, wherein an unlikely branch is treated as an unlikely branch exception (UBE) for processing.

7. The SoC of claim 6, wherein the branch and prediction executions are implemented by using static prediction.

8. The SoC of claim 4, further comprising:
on-chip interconnection configured to provide a non-blocking data path connection between the plurality of heterogeneous IP cores and the set of vesicles, wherein the on-chip interconnection is implemented based on a sorting network.

9. The SoC of claim 8, wherein the on-chip interconnection comprises a bitonic sorting network composed of a plurality of comparators and a plurality of switches, and when m IP core ports need to access n vesicle ports, a data path between the m IP core ports and the n vesicle ports is constructed by sorting related vesicle ports using the bitonic sorting network based on indexes of destination IP core ports.

10. The SoC of claim 9, wherein the on-chip interconnection comprises three bitonic sorting networks, with two for read ports and one for write ports.

11. The SoC of claim 4, wherein
the instruction includes a mixed-scale (MS) instruction, wherein the MS instruction includes a sub-instruction domain, which indicates sub-instruction information specific to one or a plurality of IP cores capable of executing the MS instruction; and
the system controller is further configured to: dispatch the MS instruction to a corresponding IP core according to the sub-instruction domain.

12. The SoC of claim 11, wherein
each MS instruction has at most two input data domains and one output data domain, which are used to indicate data information related to the execution of the MS instruction.

13. The SoC of claim 12, wherein
a data domain of an MS instruction executed on an IP core other than the mother core points to a corresponding vesicle in the set of vesicles, and a vesicle corresponding to output data is exclusively dispatched to an IP core executing the MS instruction.

14. The SoC of claim 11, wherein the plurality of heterogeneous IP cores other than the mother core are divided into different IP lanes according to their functions; and the system controller is further configured to: dispatch the MS instruction to an appropriate IP lane at least partly based on the task type of the MS instruction.

15. The SoC of claim 2, wherein the system controller is further configured to use a renaming mechanism for the vesicles to achieve one or more of the following processing:
resolving a data hazard on the vesicles;
quashing the MS instruction; and
submitting the MS instruction.

16. A board card, comprising the an SoC, wherein the SoC comprises:
a system controller configured to manage a hardware pipeline, comprising fetching an instruction from a system memory, decoding and dispatching the instruction; and
a plurality of heterogeneous IP cores constituting execution units in the hardware pipeline for executing the instruction dispatched by the system controller.

17. The board card of claim 16, further comprising:
a set of vesicles comprising a plurality of scratchpads with unequal storage capacities for caching data related to executions of the plurality of heterogeneous IP cores.

18. The board card of claim 17, wherein the capacities of the vesicles range from 64 B to 512 KB, and the number of small-capacity vesicles is greater than that of large-capacity vesicles.

19. The board card of claim 17, wherein among the plurality of heterogeneous IP cores, there is a mother core, which exclusively manages data exchange between the system memory and the vesicles.

20. The board card of claim 19, wherein the mother core is further configured to host an operating system and runtime and is responsible for at least one or more of the following:
process management, page management, exception processing, and interrupt processing.
